(19) United States
(12) Patent Application Publication
(10) Pub. No.: US 2026/0295962 A1
(43) Pub. Date: Oct. 1, 2026

(54) A PRESS APPARATUS

(71) Applicant: QUINTUS TECHNOLOGIES AB, Västeräs (SE)

(72) Inventors: Per BURSTRÖM, Västerås (SE); Anton FRITZ, Västerås (SE)

(73) Assignee: QUINTUS TECHNOLOGIES AB, Västeräs (SE)

(21) Appl. No.: 19/489,801

(22) PCT Filed: Jun. 8, 2023
(86) PCT No.: PCT/EP2023/065426

§ 371 Date: Dec. 3, 2025

(51) Int. Cl. B30B 11/00

(52) U.S. Cl. CPC B30B 11/002

(57) ABSTRACT

A press apparatus is disclosed, comprising a pressure vessel having an internal space and a first end and a second end. A load compartment is arranged within the internal space at least in part between the first end and the second end and arranged so that a flow of pressure medium through the load compartment is permitted. At least one pressure medium flow path has and extends between an inlet and an outlet in fluid communication with the internal space, and is configured to guide pressure medium from the inlet to the outlet. At least one pressure medium flow generator is configured to generate a flow of pressure medium within the internal space going through the load compartment between the second end and the first end, and further to generate a flow of the pressure medium into the inlet, through the at least one pressure medium flow path, and out of the outlet.

### TECHNICAL FIELD

The present invention relates to a press apparatus configured to treat at least one article, the press apparatus comprising a pressure vessel having an internal space and being arranged to hold pressure medium within the internal space during use of the press apparatus. The press apparatus is configured to treat the at least one article for example by means of isostatic pressing.

### BACKGROUND

An article to be subjected to pressure treatment by isostatic pressing such as Cold Isostatic Pressing (CIP), Warm Isostatic Pressing (WIP), High Pressure Processing (HPP) or Hot Isostatic Pressing (HIP) is in general positioned in a pressure vessel arranged to hold pressure medium therein. A treatment cycle may comprise loading the article in the pressure vessel, closing and sealing the pressure vessel, treating the article in the pressure vessel, opening the pressure vessel, and unloading the article from the pressure vessel. Several articles may be treated simultaneously. The treatment cycle may be divided into several parts, or phases. After loading an article into the pressure vessel, the pressure vessel may then be sealed, followed by introduction of a pressure medium (e.g., a fluid, such as a gas or liquid such as water or oil) into the pressure vessel such that the pressure in the pressure vessel is increased to a certain pressure level, which may be referred to as a pressurization phase, whereby the article may be subjected to an increased pressure during a selected period of time. The treatment cycle may comprise a heating phase, wherein the pressure medium is heated, e.g., so as to achieve a desired or required temperature thereof. The heating phase may be carried out concurrently with the pressurization phase, before the pressurization phase, or after the pressurization phase. The subjecting of the article to an increased pressure in the pressure vessel during a selected period of time may be referred to as a pressing phase, or holding phase, of the treatment cycle. After the pressing phase and prior to opening the pressure vessel to remove the article, the pressure in the pressure vessel is generally decreased to a sufficiently low level by withdrawing pressure medium from the pressure vessel. This may be referred to as a pressure reduction phase or pressure relief phase. The treatment cycle may further comprise a cooling phase. Depending on the type of isostatic press employed (e.g., whether the isostatic press is configured to carry out CIP, WIP or HIP), a cooling phase may however not be necessary.

### SUMMARY

Once a desired or required pressure in the pressure vessel and a desired or required temperature of the pressure medium have been achieved, it may be desired to hold the so achieved pressure in the pressure vessel and the temperature of the pressure medium over an extended period of time. The extended period of time may for example be a duration or substantially the entire duration of a pressing phase of the treatment cycle. The inventors have found out that in order to ensure that the temperature of the pressure medium is uniform throughout the pressure vessel—or at least throughout (or substantially throughout) a space in the pressure vessel which the at least one article that is treated is held—it may be beneficial to create and/or maintain a circulation of pressure medium within the pressure vessel (e.g., in a certain space within the pressure vessel) during the extended period of time. The space in the pressure vessel in which the at least one article that is treated is held may be referred to as an internal space and may for example be defined by a load compartment as discussed in the following. In case there is no circulation of pressure medium within the pressure vessel during such an extended period of time, thermal stratification within the pressure vessel may occur such that the temperature of the pressure medium may vary between different parts within the pressure vessel, which may lead to a non-uniform temperature distribution in the at least one article that is treated or to different temperatures between different articles or components which are treated within the pressure vessel. This may be undesired in many applications, as it could result in properties of the treated at least one article not meeting the intended specifications for the treated articles and/or different treatment conditions for different articles, which may result in different results from the treatment for different articles. One example of such applications may be treatment of solid-state battery (SSB) components, i.e., wherein the at least one article comprises, is constituted by, or is based on one or more SSB components, e.g., all-solid-state battery (ASSB) components, or semi-solid-state battery components. For example, reducing or avoiding temperature variations within different portions of the at least one treated article at the end of a pressing phase of the treatment cycle may be helpful for reducing or avoiding internal stresses in the treated article(s) during a subsequent cooling phase of the treatment cycle, and may provide an efficient way for obtaining article(s) or component(s) with uniform material properties and density while minimizing internal voids and defects without geometrical distortion of the article(s) or component(s). For example, in SSB applications, the inventors have realized that relatively high uniformity in density and other material properties of the SSB component(s) may provide an increased yield from treatment of a large number of SSB components and improve material properties of the treated products, including material properties such as porosity (such as, for example porosity of anode, cathode, electrolyte, catholyte and/or anolyte (composite) materials) and (e.g., volumetric) energy density, as well as electrical properties and electrochemical properties and capacity of the battery cell(s). By reducing the porosity of an article such as an SSB component, the volume expansion of the SSB component during charging of the SSB may decrease, which in turn may increase the lifetime of the SSB.

In view of the above, a concern of the present invention is to provide a press apparatus configured to treat at least one article, which press apparatus comprises a pressure vessel having an internal space and being arranged to hold pressure medium within the internal space during use of the press apparatus, which press apparatus is capable of reducing or even avoiding any non-uniformity in the temperature distribution in the at least one article that is treated.

To address at least one of this concern and other concerns, a press apparatus in accordance with the independent claim is provided. Embodiments of the present invention are defined by the dependent claims.

According to a first aspect of the present invention, a press apparatus is provided. The press apparatus is configured to treat at least one article. The press apparatus comprises a pressure vessel, which has an internal space and a first end and a second end. The pressure vessel is arranged to hold pressure medium within the internal space during use of the press apparatus. The press apparatus comprises a load compartment, which is arranged within the internal space at least in part between the first end and the second end. The load compartment is arranged so that a flow of pressure medium through the load compartment is permitted. The load compartment is arranged to hold at least one article therein during use of the press apparatus. The press apparatus comprises at least one pressure medium flow path, which may be configured to guide pressure medium. The at least one pressure medium flow path has and extends between an inlet located at one of the first end and the second end and an outlet located at the other one of the first end and the second end. The inlet and outlet are in fluid communication with the internal space. The at least one pressure medium flow path is configured to guide pressure medium from the inlet to the outlet. The press apparatus comprises at least one pressure medium flow generator. The at least one pressure medium flow generator is configured to generate a flow of pressure medium within the internal space going through the load compartment between the second end and the first end. The at least one pressure medium flow generator is configured to generate a flow of the pressure medium into the inlet of the at least one pressure medium flow path, through the at least one pressure medium flow path, and out of the outlet of the at least one pressure medium flow path. The press apparatus comprises a pressure medium flow distribution adjuster. The pressure medium flow distribution adjuster is arranged at the outlet of the at least one pressure medium flow path. The pressure medium flow distribution adjuster is configured to receive the flow of pressure medium exiting the at least one pressure medium flow path via the outlet thereof. The pressure medium flow distributor adjuster is configured to spread, or diverge, the received flow of pressure medium such that the distribution of the flow of pressure medium through the load compartment conforms to a selected distribution of flow of pressure medium through the load compartment.

By the pressure medium flow distributor adjuster being configured to spread, or diverge, the received flow of pressure medium, the velocity of the flow of pressure medium through the load compartment may be reduced and the static pressure of the flow of pressure medium through the load compartment may be increased, and the flow of pressure medium through the load compartment may attain a (e.g., substantially) uniform unidirectional velocity profile. The velocity and temperature of the flow of pressure medium through the load compartment may become relatively uniform across a cross-sectional area which may be perpendicular to a longitudinal axis of the load compartment. The pressure medium flow distributor adjuster may be configured to mix different flows of pressure medium, and may be configured to continuously mix fluids.

The pressure vessel may comprise a pressure cylinder, which may at least in part define the internal space. The load compartment may be defined at least in part by the walls of a container, e.g., a cylindrical container, which may be referred to as a load basket. The pressure medium flow distributor adjuster may be configured to spread the received flow of pressure medium at least in a portion of the load compartment, but possibly (and perhaps preferably) in the entire load compartment. The pressure medium flow distributor adjuster may be configured to spread the received flow of pressure medium at least in a volume of the load compartment defined by 60% or more of an inner diameter of the container defining the load compartment and the length of the load compartment, possibly at least in a volume of the load compartment defined by 85% or more of an inner diameter of the container defining the load compartment and the length of the load compartment. Possibly, the pressure medium flow distributor adjuster could be configured to spread the received flow of pressure medium at least in a volume of the internal space defined by 60% or more of an inner diameter of the pressure cylinder and the length of the pressure cylinder, possibly at least in a volume of the internal space defined by 85% or more of an inner diameter of the pressure cylinder and the length of the pressure cylinder.

By means of the provisioning of the at least one pressure medium flow path and the at least one pressure medium flow generator, creation and/or maintaining of a circulation of pressure medium within the pressure vessel, for example over an extended period of time, may be facilitated or enabled. In particular, a circulation of pressure medium within the internal space and the load compartment, for example over an extended period of time, may be created and/or maintained. As indicated in the foregoing, creation and/or maintaining such circulation of pressure medium may be advantageous for reducing or even avoiding any non-uniformity in the temperature distribution in the at least one article during use of the press apparatus, e.g., when the at least one article is treated by the press apparatus. In case there would be no circulation of pressure medium within the pressure vessel during a pressing phase of a treatment cycle, the temperature of the pressure medium may vary between different parts within the pressure vessel, which may lead to a non-uniform temperature distribution in the at least one article or to different temperatures between different articles or components which are treated within the pressure vessel, e.g., during or at least at the end of the pressing phase. As mentioned in the foregoing, this may be undesired in many applications, such as, for example, in treatment of SSB components. Reducing or avoiding temperature variations within different portions of the at least one treated article, e.g. at the end of a pressing phase of the treatment cycle, may be helpful for reducing or avoiding internal stresses in the treated article(s) during a subsequent cooling phase of the treatment cycle, and may provide an efficient way for obtaining article(s) or component(s) with a relatively high uniformity in density and other material properties while minimizing internal voids and defects without geometrical distortion of the article(s) or component(s).

Reducing or avoiding temperature variations within different portions of the at least one treated article or between different articles or components which are treated within the pressure vessel may, as indicated above, be particularly beneficial during or at least at the end of the pressing phase, i.e., during or at least at the end of a period of time when the at least one article is subjected to an increased pressure in the pressure vessel. The pressing phase may in alternative be referred to as a holding phase. However, reducing or avoiding temperature variations within different portions of the at least one treated article or between different articles or components which are treated within the pressure vessel may be beneficial also during another or other phases of a treatment cycle, such as, for example, during a heating phase wherein the pressure medium is heated, e.g., so as to achieve a desired or required temperature thereof, in order to keep the time needed to carry out a treatment cycle relatively short.

Simulations which have been carried out by the inventors have shown that by means of one or more embodiments of the present invention, any temperature variations within different portions of the at least one treated article or between different articles or components which are treated within the pressure vessel during any phase of a treatment cycle may be kept relatively small, such as less than 8° C., possibly less than 4° C. or even less than 2° C.

In SSB components, e.g., ASSB components, there are in general various solid elements which may exhibit diverse or different chemical, physical and/or mechanical properties. Because of this and further due to the nature of the coupling between such solid elements, there may be a relatively large number of internal interfaces within SSB components. In case of treatment of an SSB component such as an ASSB component, reducing or avoiding temperature variations within different portions of the SSB component may be helpful for achieving a uniform densification across internal interfaces the SSB component and a uniform densification of the solid-state electrolyte of the SSB component, and may also be beneficial for inducing desired chemical and electrochemical reactions (e.g., solid electrolyte interphase formation) at internal interfaces of the SSB component. Further, interfaces inside the SSB/ASSB (such as, for example, the interfaces between the current collector anode and the anode composite, between the cathode current collector and the cathode composite, between the cathode and solid-state electrolyte (SSE), and between the anode and SSE) may be enhanced and stabilized.

As known in the art of isostatic pressing, the at least one article to be treated may be placed in a bag or pouch prior to the treatment. By reducing or avoiding temperature variations within different portions of the at least one treated article, any warpage or distortion of the bag or pouch may be mitigated or even eliminated.

Further, by means of the provisioning of the pressure medium flow distribution adjuster, the distribution of the flow of pressure medium through the load compartment during such circulation of pressure medium within the internal space and the load compartment can be tailored or adapted so as to conform to a selected distribution of flow of pressure medium through the load compartment. The selected distribution of flow of pressure medium through the load compartment could be referred to as a selected flow profile of the pressure medium in the load compartment. Tailoring or adapting the distribution of the flow of pressure medium through the load compartment so as to conform to a selected distribution of flow of pressure medium through the load compartment may (further) facilitate ensuring that properties of the treated at least one article meet the intended specifications.

In the context of the present application, by the distribution of the flow of pressure medium through the load compartment conforming to a selected distribution of flow of pressure medium through the load compartment, it may be meant that the distribution of the flow of pressure medium through the load compartment becomes similar to or substantially the same as the selected distribution of flow of pressure medium through the load compartment, but not necessarily that the distribution of the flow of pressure medium through the load compartment and the selected distribution of flow of pressure medium through the load compartment in are in exact conformance (but they could be).

It is to be noted that the pressure medium flow distribution adjuster arranged at the outlet of the at least one pressure medium flow path as described in the foregoing (and also as described in the following, e.g., with reference to the figures), may be omitted. While the pressure medium flow distribution adjuster may provide benefits as described in the foregoing (and also as described in the following), the pressure medium flow distribution adjuster is not required for creating and/or maintaining of a circulation of pressure medium within the pressure vessel.

The press apparatus may be configured to treat at least one article by means of isostatic pressing. Treatment by means of isostatic pressing facilitates or allows for achieving the same material properties of all articles treated by the press apparatus. For example, the press apparatus may be configured to treat at least one article by means of at least one of CIP, WIP, HPP or HIP.

In general, the treatment by means of CIP may involve a temperature in the pressure vessel that is equal to or lower than (e.g., about) 50° C., e.g., in a range between (e.g., about) room temperature (e.g., 20° C.) and (e.g., about) 50° C., in the pressure vessel. Further, the treatment by means of CIP may involve a pressure in the pressure vessel that is in a range between (e.g., about) 50 MPa to (e.g., about) 1600 MPa, such as between (e.g., about) 50 MPa to (e.g., about) 600 MPa, depending on material of the article(s) being treated and the temperature in the pressure vessel.

In general, the treatment by means of WIP may involve a temperature in the pressure vessel that is in a range between (e.g., about) 50° C. and (e.g., about) 400° C., in the pressure vessel. Further, the treatment by means of WIP may involve a pressure in the pressure vessel that is in a range between (e.g., about) 50 MPa to (e.g., about) 1600 MPa, such as between (e.g., about) 50 MPa to (e.g., about) 600 MPa, depending on material of the article(s) being treated and the temperature in the pressure vessel.

In general, the treatment by means of HIP may involve a temperature in the pressure vessel that is equal to or higher than (e.g., about) 400° C., e.g., in a range between (e.g., about) 400° C. and (e.g., about) 2500° C., in the pressure vessel. Further, the treatment by means of HIP may involve a pressure in the pressure vessel that is in a range between (e.g., about) 50 MPa to (e.g., about) 300 MPa, such as between (e.g., about) 50 MPa to (e.g., about) 210 MPa, depending on material of the article(s) being treated and the temperature in the pressure vessel.

In general, the treatment by means of HPP may involve a temperature in the pressure vessel that is equal to or higher than (e.g., about) 0° C., e.g., in a range between (e.g., about) 0° C. and (e.g., about) 100° C., typically in a range between (e.g., about) 4° C. and (e.g., about) 40° C., in the pressure vessel. Further, the treatment by means of HPP may involve a pressure in the pressure vessel that is in a range between (e.g., about) 100 MPa to (e.g., about) 800 MPa, commonly between (e.g., about) 400 MPa to (e.g., about) 600 MPa, depending on material of the article(s) being treated and the temperature in the pressure vessel.

Depending on the application, it may however be desired or even required to achieve a pressure in the pressure vessel as high as 6000 bar (600 MPa), or even higher. In order to increase the pressure in the pressure vessel during the pressurization phase, pumps, such as hydraulic pumps, may be used to introduce pressure medium into the pressure vessel in order to increase the pressure in the pressure vessel. However, such pumps may not be capable of generating a pressure in the pressure vessel as high as 6000 bar, and may only be practically utilized for generating a (much) lower pressure in the pressure vessel. This may for example be due to that constructional materials used in such pumps may not be able to withstand the desirable pressure level, at which the mechanical stress on components of the pumps such as valves and piping may be deleteriously high such that the components may break after a relatively short time of use of the pumps. Therefore, such pumps are often used to generate a pressure in the pressure vessel to a pressure level that the pump can safely withstand, followed by further pressurization by means of other devices that can withstand the desirable pressure level. Such other devices may be constituted by so-called pressure intensifiers. The increasing of the pressure in the pressure vessel by means of the pressure intensifier units feeding pressure medium into the pressure vessel may be carried out subsequently to a pressurization of the pressure vessel employing pumps, such as hydraulic pumps, to introduce pressure medium into the pressure vessel. For example, a pressurization of the pressure vessel employing pumps, such as hydraulic pumps, to introduce pressure medium into the pressure vessel, may first be carried out in order to reach a certain pressure level in the pressure vessel, e.g., about 20 bar. Subsequently, the increasing of the pressure in the pressure vessel by means of the pressure intensifier units feeding pressure medium into the pressure vessel and the said pressure increasing phase may be carried out in order to reach a (much) higher pressure level of the pressure in the pressure vessel, e.g., up to 6000 bar or even higher.

The pressure vessel may for example have cylindrical shape. However, while a cylindrical shape of the pressure vessel may be preferred, the pressure vessel could have another shape than a cylindrical shape.

In use, the pressure vessel may for example be arranged such that a longitudinal axis of the pressure vessel is oriented perpendicular or substantially perpendicular to a vertical line (e.g., a plumb line), or such that a longitudinal axis of the pressure vessel is oriented parallel to or substantially parallel to a vertical line (e.g., a plumb line).

The pressure medium may for example comprise a fluid, such as a liquid and/or a gas. The fluid may for example comprise water and/or oil and/or another appropriate liquid. The oil may for example comprise mineral oil. The gas may for example comprise an inert gas, such as argon gas.

The “use of the press apparatus” may refer to in principle any use of the press apparatus related to the treatment of the at least one article. For example, the pressure vessel may be arranged to hold pressure medium within the internal space for example during a pressurization phase, a heating phase, a pressing phase and/or another phase of a treatment cycle as mentioned in the foregoing. Thus, “use of the press apparatus” may refer to, e.g., one or more of pressurization, heating, pressing, or cooling, or any combination of such phases and any other possible phases of a treatment cycle.

As mentioned, after loading an article into the pressure vessel, the pressure vessel may then be sealed. This may be followed by a pressurization phase and/or a heating phase. The pressurization phase and the heating phase may be carried out concurrently. The pressurization phase may involve introduction of a pressure medium into the (sealed) pressure vessel to attain a selected pressure within the pressure vessel. The heating phase may involve heating the pressure medium, e.g., so as to achieve a desired or required temperature thereof. Possibly, prior to introducing the pressure medium into the pressure vessel, the pressure medium may be preheated to a temperature that takes account of the adiabatic heating that occurs because of pressurizing of the pressure medium inside of the pressure vessel. Such adiabatic heating may for example be (about) 2-9° C./100 MPa, depending on media composition. By preheating pressure medium prior to introducing the pressure medium into the pressure vessel and then pressurizing the pressure medium inside the pressure vessel, a temperature of the pressure medium within 2° C.-5° C. of the desired or required temperature, for example, may be achieved. Thus, the preheated pressure medium may be introduced into the pressure vessel. Subsequently, the temperature of the pressure medium may be adjusted to the desired or required temperature (or to almost the desired or required temperature) by means of adjusting the pressure in the pressure vessel such that the desired or required temperature (or to almost the desired or required temperature) is reached by means of adiabatic heating of the pressure medium. Thus, by means of such adiabatic heating, the temperature of the pressure medium in the pressure vessel may be increased by, e.g., 2° C.-5° C., in order to reach the desired or required temperature (or to almost the desired or required temperature. The preheating of the pressure medium may for example be carried out using one or more heaters, e.g., one or more electrical heaters, arranged in relation to a pressure medium source or reservoir connected or connectable to the pressure vessel so as to be able to heat the pressure medium while in the pressure medium source or reservoir.

As mentioned, the pressure medium may for example comprise water. Water is normally considered to be incompressible. At very high pressures, however, water is compressible, and heat is developed during the compression. In principle, the temperature of water increases by approximately 4° C. for every 1000 bar up to 6000 bar. The interaction between the amount of (solid) load or article(s) to be treated and the pressure medium (e.g., water) may affect how operation of a press apparatus configured to treat at least one article by means of, e.g., WIP is or should be controlled. The solid load/article(s) will be negligibly compressible in comparison to the pressure medium, and the temperature increase of the solid load/article(s) as a result of the pressure increase will therefore not be the same as the temperature increase of the pressure medium as a result of the pressure increase. The thermal properties of the load/article(s) should be taken into account when choosing how to control operation of a press apparatus configured to treat at least one article by means of, e.g., WIP (e.g., when choosing control parameters for such operation). For example, the pressure build-up speed and which preheating temperature to be used (if any) should be considered. Because the increase in temperature of the pressure medium over a given period of time during a pressure build-up sequence may be different than the increase in temperature of the load/article(s) over that period of time during a pressure build-up sequence, depending on the above-mentioned considerations, this should be taken into account for determining which pressure build-up speed to use. A rapid pressure build-up may not be required in case the temperature of the load/article(s) is held at a constant level below the target ‘hold’ temperature for a certain time during the time it takes to reach the target ‘hold’ pressure. This means that a slower pressure build-up in some cases may be preferred in order to be able to reach the target ‘hold’ temperature and the target ‘hold’ pressure simultaneously or substantially simultaneously. Also, the controlling of the operation may also need to take into account any nominal maximum temperature and/or a nominal maximum pressure which may not be permitted to be exceeded due to safety reasons or depending on desired material properties of the treated article(s).

By the at least one pressure medium flow generator being configured to generate a flow of pressure medium within the internal space going through the load compartment between the second end and the first end, there may be generated a flow of pressure medium within the internal space from the outlet of the at least one pressure medium flow path to, or at least towards, the inlet of the at least one pressure medium flow path.

Generally, the at least one pressure medium flow path may be different from the internal space and the load compartment. In general, the at least one pressure medium flow path can be considered to be a part of the press apparatus that is separate from the internal space and/or the load compartment, and possibly such that the pressure medium, when it is being conveyed in the at least one pressure medium flow path, does not mix with the pressure medium that is in the internal space and/or the load compartment.

The at least one pressure medium guiding conduit may be configured to guide pressure medium out of the internal space and into the inlet, guide the pressure medium introduced into the inlet from the inlet to the outlet, and guide the pressure medium out of the outlet and back into the internal space.

The at least one pressure medium flow path may for example comprise at least one of one or more conduits, one or more channels, one or more pipes, one or more tubes, etc., which may be configured to guide pressure medium therethrough.

In alternative or in addition, the at least one pressure medium flow path may for example be formed by one or more passageways between two or more different components, parts or portions of the press apparatus. For example, the internal space may be defined by an interior of the load compartment which may be defined by the walls of a container, e.g., a cylindrical container, which may be referred to as a load basket. The container may be at least in part enclosed by an enclosure, e.g., a liner or jacket, which for example may be cylindrical. In such a case, the at least one pressure medium flow path may comprise or be constituted by a gap between the outer surface of the walls of the container and an inner surface of the enclosure.

The at least one pressure medium flow path may for example be arranged at least in part within the internal space. For example, the at least one pressure medium flow path may comprise or be constituted by one or more conduits, one or more channels, one or more pipes, one or more tubes, etc. which may be at least in part arranged in the load compartment. In that case, the internal space may be at least in part defined by the space within the load compartment except for the space defined by the at least one pressure medium flow path arranged in the load compartment, and possibly also space outside the load compartment. According to one specific example, the at least one pressure medium flow path may comprise a tube, pipe or conduit extending through and along the load compartment. For example, in case the load compartment has a cylindrical geometry, the at least one pressure medium flow path may comprise a tube, pipe or conduit extending axially through the load compartment.

In alternative or in addition, the at least one pressure medium flow path may be arranged at least in part within the pressure vessel in one or more parts thereof different from the internal space. One example of such a configuration has been described in the foregoing in which the at least one pressure medium flow path may comprise or be constituted by a space or gap between the outer surface of the walls of a container (e.g., an outer envelope surface of the container), the interior of which may define the internal space or the load compartment, and an inner surface of an enclosure enclosing the container. The space or gap which may define the pressure medium flow path could be replaced by a semi-solid liner or jacket, which may include one or more conduits, pipes, passageways or the like extending within the liner or jacket along the length of the container. In alternative, a part of the space or gap which may define the pressure medium flow path could accommodate such a liner or jacket. In alternative or in addition, the pressure medium flow path could be realized by means of one or more conduits, channels, pipes, passageways or the like arranged within a container defining the load compartment and extending along a length of the container. For example, the container defining the load compartment could be configured as a cylinder, or at least with a cylindrical shape, with such one or more conduits, channels, pipes, passageways or the like being arranged within the cylindrical walls of the container and which may run along at least a part of the length thereof.

In alternative or in addition, the at least one pressure medium flow path may be arranged at least in part outside the pressure vessel. The at least one pressure medium flow path may exit the pressure vessel at one of the first end and the second end and enter the pressure vessel at the other one of the first end and the second end.

The at least one pressure medium flow path may comprise several pressure medium flow paths, wherein each of the several pressure medium flow paths may be configured according to one of the different configurations of the at least one pressure medium flow path described herein. For example, each of the several pressure medium flow path may be arranged at least in part within the internal space, be arranged at least in part outside the pressure vessel, or be arranged at least in part within the pressure vessel in one or more parts thereof different from the internal space. Thus, the press apparatus may comprise several pressure medium flow paths in any combination of configurations of the at least one pressure medium flow path described herein.

The at least one pressure medium flow generator may for example comprise at least one of: at least one fan, at least one ejector, at least one pump, or at least one pressure intensifier.

As mentioned, the pressure vessel has (e.g., at least) a first end and a second end. In the context of the present application, by an end of the pressure vessel it may in general be meant a part of a region within the pressure vessel that lies at a boundary between an interior of the pressure vessel and the exterior of the pressure vessel. The first end and the second end must not necessarily be opposite ends, but they could be. The first end and the second end may be respective parts of different regions within the pressure vessel that lie at a boundary between an interior of the pressure vessel and the exterior of the pressure vessel. According to one example, the pressure vessel may comprise one or more end closures, such as a first end closure and a second end closure, each of which may be selectively opened and closed. The first end and the second end could be at different end closures, but this is not required, and the first end and the second end might be at the same end closure.

The pressure medium flow distribution adjuster arranged at the outlet of the at least one pressure medium flow path may for example comprise one or more diffusers, e.g., one or more diffusers of a type known in the art. The pressure medium flow distribution adjuster arranged at the outlet of the at least one pressure medium flow path may, in one or more embodiments of the present invention, be referred to as a diverging diffuser, or a diverging outlet diffuser. The diffuser(s) may for example comprise a structure made of a porous material.

The pressure vessel may comprise an enclosing structure. The enclosing structure may be configured to sealingly enclose at least the internal space.

In the context of the present application, by the enclosing structure being configured to sealingly enclose at least the internal space, it may be meant that by the provisioning of the enclosing structure there may be no or substantially no leakage of pressure medium (e.g., only an insignificant amount of leakage over a certain period of time) from the internal space unless the pressure medium is intentionally guided out of the internal space via an exit or outlet of the enclosing structure or of the pressure vessel.

The pressure vessel may comprise a pressure cylinder. The pressure vessel may comprise one or more end closures, such as a first end closure and a second end closure, each of which end closures may be arranged to be capable of being selectively opened and closed. The pressure vessel may comprise a pressure cylinder and one or more end closures, such as a first end closure and a second end closure. Possibly, an end closure of the pressure vessel could be constituted by a part of the pressure cylinder. Each or any of the first end closure and/or the second end closure may for example include or be constituted by a lid. The second end closure may be opposite to the first end closure. For example, the first end closure and the second end closure may be arranged at opposite ends of the pressure vessel (or pressure cylinder). Thus, the first end closure may be at the first end of the pressure vessel and the second end closure may be at the second end of the pressure vessel, or the second end closure may be at the first end of the pressure vessel and the first end closure may be at the second end of the pressure vessel. At least the pressure cylinder may be included in or constitute the enclosing structure. For example, the pressure cylinder, the first end closure, and the second end closure may be included in or constitute the enclosing structure.

On the outer surface of the outer walls of the pressure cylinder or the pressure vessel there may be arranged channels, conduits and/or tubes, etc., which a flow of coolant may be provided for cooling of the outer walls of the pressure cylinder or pressure vessel. On the outer surface of the outer walls of the pressure cylinder or pressure vessel, and possibly on any channels, conduits and/or tubes, etc. for coolant, pre-stressing means may be provided. The pre-stressing means may for example be provided in the form of wires (e.g., made of steel) which may be wound in a plurality of turns so as to form one or more bands, and preferably in several layers, around the outer surface of the outer walls of the pressure cylinder or pressure vessel and possibly also any channels, conduits and/or tubes, etc. for coolant that may be provided thereon. The prestressing means may be arranged for exerting radial compressive forces on the pressure cylinder or pressure vessel. According to one example, the pressure vessel may be of the so-called monoblock type, in which case prestressing means as described above might not be used.

Further, the press apparatus may comprise axial prestressing means for accommodating axial forces which may be exerted on one or more of the end closures of the pressure vessel. Such axial prestressing means may for example comprise a frame, which may be arranged to hold one or more of the end closures of the pressure vessel. The frame may extend on the outside of the pressure vessel from an end closure at one end of the pressure vessel to an end closure at another end of the pressure vessel.

Generally, it may be desired for the load compartment to be as large as practically possible—or at least relatively large—in order to be able to treat a relatively large number of articles simultaneously using the press apparatus. To facilitate for arranging the load compartment to be relatively large or as large as practically possible, the internal space should be relatively large or as large as practically possible. Different ways for how that may be achieved are described herein.

For example, the at least one of the at least one pressure medium flow generator or the pressure medium flow distribution adjuster may be built-in in or integrated into the enclosing structure. In addition or in alternative, the enclosing structure could comprise at least one cavity which may be in fluid communication with the internal space, wherein at least one of the at least one pressure medium flow generator or the pressure medium flow distribution adjuster may be disposed in the at least one cavity. In addition or in alternative, at least one of the at least one pressure medium flow generator or the pressure medium flow distribution adjuster could be recessed in an inner surface of the enclosing structure, which inner surface may face the internal space (e.g., a surface normal of the inner surface may be directed inwards, into the internal space).

As mentioned, the pressure vessel may comprise one or more end closures, such as a first end closure and a second end closure. For example, the at least one pressure medium flow generator may be built-in or integrated into the first end closure and/or the second end closure. The pressure medium flow distribution adjuster may be built-in or integrated into the first end closure and/or the second end closure. The first end closure and/or the second end closure may comprise at least one cavity which may be in fluid communication with the internal space, wherein the at least one pressure medium flow generator may be disposed in the at least one cavity. The first end closure and/or the second end closure may comprise at least one cavity in fluid communication with the internal space, wherein the pressure medium flow distribution adjuster may be disposed in the at least one cavity. In addition or in alternative, the at least one pressure medium flow generator may be recessed in an inner surface of the first end closure and/or the second end closure, which inner surface may face the internal space. In addition or in alternative, the pressure medium flow distribution adjuster may be recessed in an inner surface of the second end closure, which inner surface may face the internal space. By the inner surface facing the internal space it may be meant that a surface normal of the inner surface may be directed inwards, into the internal space.

By configurations such as described in the two immediately preceding paragraphs, there may be needed no or little space within the internal space for accommodating the at least one pressure medium flow generator or the pressure medium flow distribution adjuster, so that a relatively large proportion of the volume of the internal space or even the entire volume of the internal space can be used for accommodating the load compartment.

The pressure medium flow distribution adjuster referred to in the foregoing may be considered to be a first pressure medium flow distribution adjuster. The press apparatus may comprise an additional, second pressure medium flow distribution adjuster, which may be configured to receive the flow pressure medium exiting the load compartment and converge the flow of pressure medium towards the inlet of the at least one pressure medium flow path such that the converged flow of pressure medium enters the at least one pressure medium flow path at the inlet thereof.

The second pressure medium flow distribution adjuster, which may be arranged at the inlet of the at least one pressure medium flow path may for example comprise one or more diffusers, e.g., one or more diffusers of a type known in the art. The second pressure medium flow distribution adjuster may, in one or more embodiments of the present invention, be referred to as a converging diffuser, a converging inlet diffuser, a converging nozzle, or a converging inlet nozzle.

As mentioned, the pressure vessel may comprise an enclosing structure configured to sealingly enclose at least the internal space. At least one of the at least one pressure medium flow generator, the second pressure medium flow distribution adjuster or the first pressure medium flow distribution adjuster may be built-in in or integrated into the enclosing structure. In alternative or in addition, the enclosing structure may comprise at least one cavity which may be in fluid communication with the internal space, wherein at least one of the at least one pressure medium flow generator, the second pressure medium flow distribution adjuster or the first pressure medium flow distribution adjuster may be disposed in the at least one cavity. In alternative or in addition, at least one of the at least one pressure medium flow generator, the second pressure medium flow distribution adjuster, or the first pressure medium flow distribution adjuster may be recessed in an inner surface of the enclosing structure, the inner surface facing the internal space. By the inner surface facing the internal space it may be meant that a surface normal of the inner surface may be directed inwards, into the internal space.

As mentioned, the pressure vessel may comprise one or more end closures, such as a first end closure and a second end closure. For example, the at least one pressure medium flow generator may be built-in or integrated into the first end closure and/or the second end closure. The first pressure medium flow distribution adjuster may be built-in or integrated into one of the first end closure and the second end closure, and the second pressure medium flow distribution adjuster may be built-in or integrated into the first end closure and/or the second end closure. In alternative or in addition, the first end closure and/or the second end closure may comprise at least one cavity in fluid communication with the internal space, wherein the at least one pressure medium flow generator may be disposed in the at least one cavity. One of the first end closure and the second end closure may comprise at least one cavity which may be in fluid communication with the internal space, wherein the second pressure medium flow distribution adjuster may be disposed in at least one cavity, and the other one of the first end closure and the second end closure may comprise at least one cavity which may be in fluid communication with the internal space, wherein the first pressure medium flow distribution adjuster may be disposed in at least one cavity. In alternative or in addition, the at least one pressure medium flow generator pressure medium may be recessed in an inner surface of the first end closure and/or the second end closure, which inner surface faces the internal space. In alternative or in addition, the first pressure medium flow distribution adjuster may be recessed in an inner surface of one of the first end closure and the second end closure, with the inner surface facing the internal space, and the second pressure medium flow distribution adjuster may be recessed in an inner surface of the other one of the first end closure and the second end closure, with the inner surface facing the internal space. By the inner surface facing the internal space it may be meant that a surface normal of the inner surface may be directed inwards, into the internal space.

By configurations such as described in the two immediately preceding paragraphs, there may be needed no or little space within the internal space for accommodating the at least one pressure medium flow generator or the pressure medium flow distribution adjuster, so that a relatively large proportion of the volume of the internal space or even the entire volume of the internal space can be used for accommodating the load compartment.

The press apparatus may comprise a heating unit, which may be configured to heat the pressure medium being guided in the at least one pressure medium flow path from the inlet to the outlet.

The press apparatus may comprise a cooling unit, which may be configured to cool the pressure medium being guided in the at least one pressure medium flow path from the inlet to the outlet.

The heating unit and the cooling unit may be configured to heat and cool, respectively, the pressure medium being guided in the at least one pressure medium flow path from the inlet to the outlet at different locations along the at least one pressure medium flow path.

The heating unit and/or the cooling unit may for example comprise at least one heat exchanger unit.

As mentioned, the at least one pressure medium flow path may be arranged at least in part outside the pressure vessel. The heating unit and/or the cooling unit may be configured to heat or cool, respectively, the pressure medium when being guided in the at least one pressure medium flow path from the inlet to the outlet in a part of the at least one pressure medium flow path arranged outside the pressure vessel.

For example in case the at least one pressure medium flow path is arranged at least in part outside the pressure vessel, the cooling unit may be arranged downstream the inlet of the at least one pressure medium flow path and configured to cool the pressure medium being guided in the at least one pressure medium flow path. At least one of the at least one pressure medium flow generator may be arranged downstream the cooling unit and configured to receive the flow of the pressure medium having been cooled by the cooling unit and generate a flow of the pressure medium in the at least one pressure medium flow path towards the outlet. The cooling unit may be configured to cool the pressure medium being guided in the at least one pressure medium flow path such that the temperature of the pressure medium received by said at least one of the at least one pressure medium flow generator does not exceed a selected temperature. The heating unit may be arranged downstream said at least one of the at least one pressure medium flow generator and upstream the outlet, and may be configured to heat the pressure medium being guided in the at least one pressure medium flow path such that the temperature of the pressure medium in the pressure medium flow out of the outlet exceeds or conforms to a selected temperature.

Such a configuration may be particularly advantageous in case the above-mentioned at least one pressure medium flow generator arranged downstream the cooling unit is of a type or configuration that may not function or operate properly or even malfunction in case the temperature of the pressure medium received by the pressure medium flow generator(s) is relatively high. During use of the press apparatus, the temperature of the pressure medium may become relatively high. As mentioned, the press apparatus may be configured to treat at least one article by means of isostatic pressing, in which case the temperature of the pressure medium may become relatively high. In case the temperature of the pressure medium guided into the at least one pressure medium flow path becomes too high for the above-mentioned at least one pressure medium flow generator arranged downstream the cooling unit to function or operate properly, the cooling unit may cool the pressure medium being guided in the at least one pressure medium flow path such that the temperature of the pressure medium received by the above-mentioned at least one pressure medium flow generator does not exceed a temperature above which the above-mentioned at least one pressure medium flow generator arranged downstream the cooling unit may not function or operate properly or possibly even malfunction. Then, the heating unit may heat the pressure medium being guided in the at least one pressure medium flow path such that the temperature of the pressure medium in the pressure medium flow out of the outlet exceeds or conforms to a selected temperature, which may be the temperature of the pressure medium when guided into the at least one pressure medium flow path via the inlet thereof.

The above-mentioned at least one pressure medium flow generator arranged downstream the cooling unit may for example comprise at least one pressure intensifier.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the present invention will be described below with reference to the accompanying drawings.

FIG. 1 is a schematic, in part sectional, perspective view of a press apparatus according to an embodiment of the present invention.

Each of FIGS. 2 and 4 is a schematic view of a portion of the press apparatus illustrated in FIG. 1 at one of the ends of the pressure vessel of the press apparatus.

FIG. 3 is a schematic view of a portion of the press apparatus illustrated in FIG. 1 at the other end of the pressure vessel of the press apparatus.

FIG. 5 is a schematic, in part sectional, perspective view of a press apparatus according to an embodiment of the present invention.

Each of FIGS. 6 and 7 is a schematic view of a portion of the press apparatus illustrated in FIG. 5 at one of the ends of the pressure vessel of the press apparatus.

FIG. 8 is a schematic view of a portion of a press apparatus similar to the press apparatus illustrated in FIG. 5 at one of the ends of the pressure vessel of the press apparatus.

FIG. 9 is a schematic, in part sectional, perspective view of a press apparatus according to an embodiment of the present invention.

Each of FIGS. 10 and 11 is a schematic view of a portion of the press apparatus illustrated in FIG. 9 at one of the ends of the pressure vessel of the press apparatus.

FIG. 12 is a schematic view of a portion of the press apparatus illustrated in FIG. 9 at the other end of the pressure vessel of the press apparatus.

FIG. 13 is a schematic, in part sectional, perspective view of a press apparatus according to an embodiment of the present invention.

Each of FIGS. 14 and 15 is a schematic view of a portion of the press apparatus illustrated in FIG. 13 at one of the ends of the pressure vessel of the press apparatus.

FIG. 16 is a schematic view of a portion of the press apparatus illustrated in FIG. 13 at the other end of the pressure vessel of the press apparatus.

FIG. 17 is a schematic view of a press apparatus according to an embodiment of the present invention.

FIG. 18 is a schematic, cross-sectional view of a pressure vessel of a press apparatus according to an embodiment of the present invention.

FIG. 19 is a schematic, in part sectional, perspective view of a press apparatus according to an embodiment of the present invention.

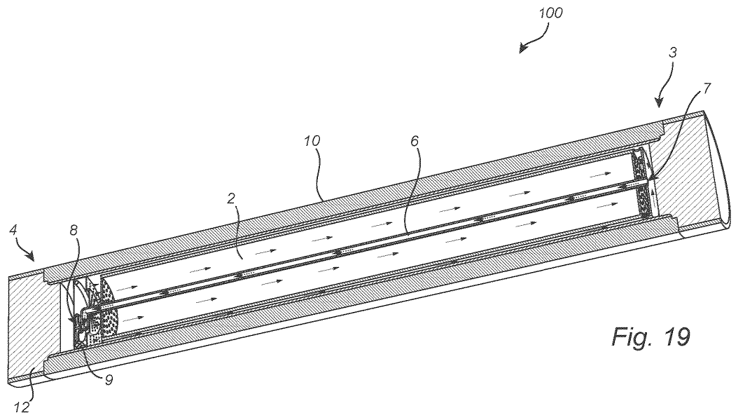

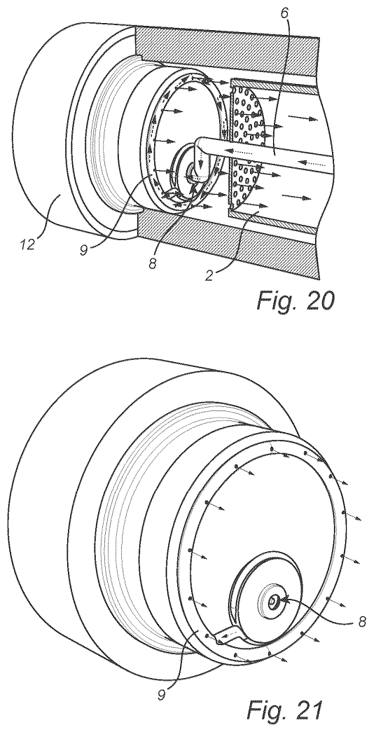

Each of FIGS. 20 and 21 is a schematic view of a portion of the press apparatus illustrated in FIG. 19 at one of the ends of the pressure vessel of the press apparatus.

The figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are illustrated. The present invention may, however, be embodied in many different forms and should not be construed as limited to the embodiments of the present invention set forth herein; rather, these embodiments are provided by way of example so that this disclosure will convey the scope of the present invention to those skilled in the art.

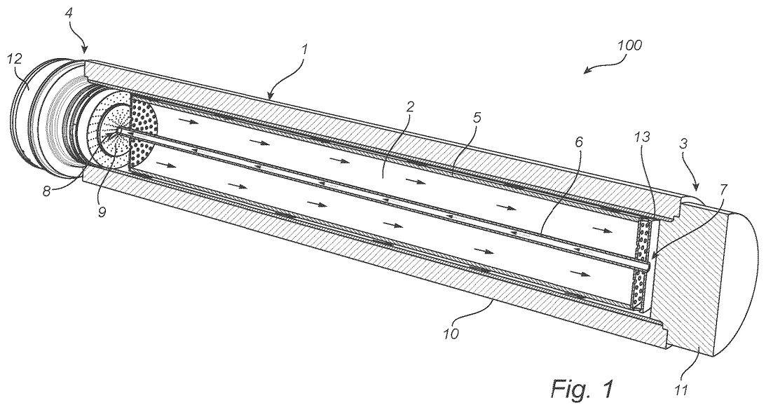

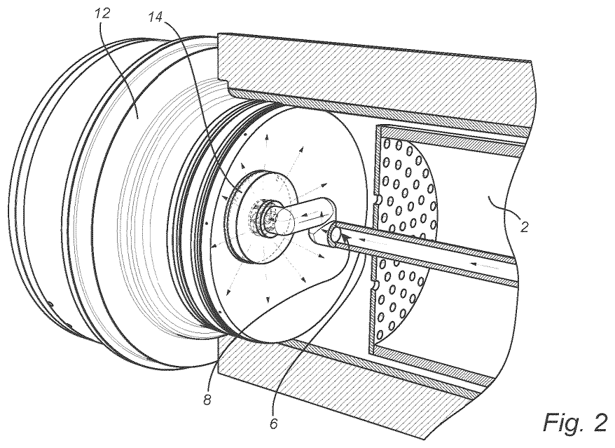

FIG. 1 is a schematic, in part sectional, perspective view of a press apparatus 100 according to an embodiment of the present invention. The press apparatus 100 is configured to treat at least one article (not shown in FIG. 1). The press apparatus 100 may be configured to treat the at least one article by means of isostatic pressing. For example, the press apparatus 100 may be configured to treat at least one article by means of CIP, WIP or HIP.

The press apparatus 100 comprises a pressure vessel 1, which has an internal space 5. In accordance with the embodiment of the present invention illustrated in FIG. 1, the pressure vessel 1 has a cylindrical shape. While a cylindrical shape of the pressure vessel 1 may be preferred, the pressure vessel 1 could have another shape than a cylindrical shape. The pressure vessel 1 is arranged to hold pressure medium within the internal space 5 during use of the press apparatus 100. The pressure medium may for example comprise a fluid such as a liquid or a gas. The fluid may for example comprise water and/or an oil, e.g., mineral oil. The gas may for example comprise an inert gas, such as argon gas.

Further in accordance with the embodiment of the present invention illustrated in FIG. 1, the pressure vessel 1 comprises a pressure cylinder 10 (which might be referred to only as a cylinder), a first end closure 11 and a second end closure 12. Although not explicitly illustrated in FIG. 1, one or both of the first end closure 11 and the second end closure 12 can be configured so as to be capable of being opened and closed, e.g., using opening and closing means such as known in the art. The second end closure 12 is opposite to the first end closure 11. The pressure vessel 1 has a first end 3 and a second end 4. Generally, the first end closure 11 may be at one of the first end 3 of the pressure vessel 1 and the second end 4 of the pressure vessel 1 and the second end closure 12 may be at the other one of the first end 3 of the pressure vessel 1 and the second end 4 of the pressure vessel 1. As illustrated in FIG. 1 and hence according to the illustrated embodiment of the present invention, the first end closure 11 is at the first end 3 of the pressure vessel 1 and the second end closure 12 is at the second end 4 of the pressure vessel 1.

The press apparatus 100 comprises a load compartment 2, which is arranged within the internal space 5 between the first end 3 and the second end 4. The load compartment 2 is arranged so that a flow of pressure medium through the load compartment 2 is permitted. The load compartment 2 is arranged to hold at least one article therein during use of the press apparatus 100.

In accordance with the embodiment of the present invention illustrated in FIG. 1, the load compartment 2 is defined by the walls of a cylindrical container, which cylindrical container may be referred to as a load basket without loss of generality, and the internal space 5 may be at least in part defined by the load compartment 2, such as for example, by an interior of a (e.g., cylindrical) container defining the load compartment 2. At least the envelope surface of the container may be impervious for pressure medium. At one or more ends of the container (e.g., at a bottom end and/or at a top end of the container) there may be provided one or more through-holes permitting passage of pressure medium therethrough, whereby a flow of pressure medium through the load compartment 2 is permitted. The container, or load basket, may be made of in principle any material capable of withstanding the pressures at which the at least one article is intended to be treated at. The container, or load basket, may for example be made of steel or another iron-based alloy. It may be preferred for the container, or load basket, to be made of a material having relatively low thermal conductivity, such as, for example a polymer or plastic material. Other materials having relatively low thermal conductivity are however contemplated.

It is to be understood that while a cylindrical geometry of the pressure vessel 1, the internal space 5 and the load compartment 2 as illustrated in FIG. 1 may be the preferable geometry—or one of the preferable geometries—such a geometry of the pressure vessel 1, the internal space 5 and the load compartment 2 is not required, and another or other types of geometries of such components are possible.

Generally, the press apparatus 100 comprises at least one pressure medium flow path having and extending between an inlet located at one of the first end 3 and the second end 4 and an outlet located at the other one of the first end 3 and the second end 4, which inlet and outlet are in fluid communication with the internal space 5, and with the at least one pressure medium flow path being configured to guide pressure medium from the inlet to the outlet. In accordance with the embodiment of the present invention illustrated in FIG. 1, the press apparatus 100 comprises a pressure medium flow path 6 having and extending between an inlet 7 located at the first end 3 and an outlet 8 located at the second end 4, with the inlet 7 and outlet 8 being in fluid communication with the internal space, and with the pressure medium flow path 6 being configured to guide pressure medium from the inlet 7 to the outlet 8.

In accordance with the embodiment of the present invention illustrated in FIG. 1, the pressure medium flow path 6 is arranged at least in part within the internal space 5 and comprises a tube, pipe or conduit extending axially through the load compartment 2. Thus, according to the illustrated embodiment of the present invention, the internal space 5 is at least in part defined by the space within the load compartment 2 outside the tube, pipe or conduit defining the pressure medium flow path 6.

It is to be understood that the components of the press apparatus 100 may be relatively large. Possibly, components of the press apparatus 100 such as, for example, any container or load basket which may define the load compartment 2, and/or any tube, pipe, conduit, etc., which may define the pressure medium flow path 6, could be constructed from multiple parts which may be interconnected in any appropriate way, e.g., depending on the material of such parts, e.g., by means of a docking arrangement or by means of welding, soldering or the like.

The press apparatus 100 comprises a pressure medium flow generator (not shown in FIG. 1; cf. FIG. 2) configured to generate a flow of pressure medium within the internal space 5 going through the load compartment 2 between the second end 4 and the first end 3. The at least one pressure medium flow generator is configured to generate a flow of the pressure medium into the inlet 7 of the pressure medium flow path 6, through the at least one pressure medium flow path 6, and out of the outlet 8 of the pressure medium flow path 6.

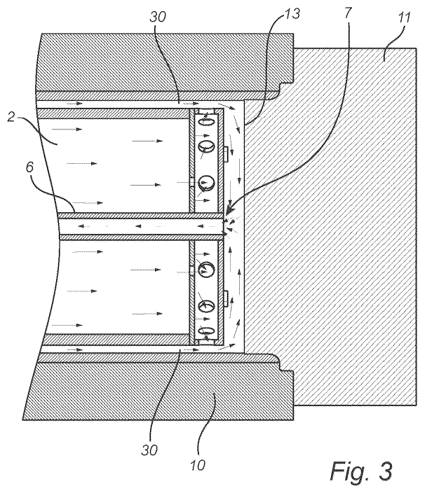

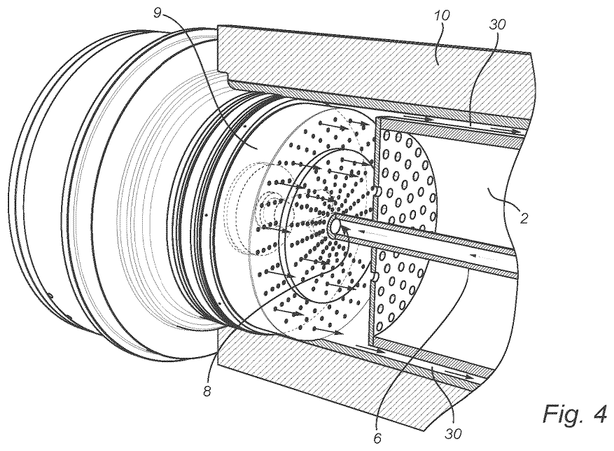

By means of the provisioning of the pressure medium flow path 6 and the at least one pressure medium flow generator, it may be facilitated or enabled to create and/or maintain of a circulation of pressure medium within the pressure vessel 1, for example over an extended period of time. In particular, a circulation of pressure medium within the internal space 5 and the load compartment 2, for example over an extended period of time, may be created and/or maintained. During circulation of pressure medium within the internal space 5, there may be a flow of pressure medium through only a portion of the internal space 5 or through the entire or substantially the entire internal space 5. For example, there may be a flow of pressure medium both through the load compartment 2, which as mentioned may be defined by the walls of a cylindrical container, as well as through a space outside the container, which space may be extending along the envelope surface of the container. The container may hence not take up the entirety of the internal space 5, but there may for example be a gap between an inner surface of the pressure vessel 1 and an outer surface of the load compartment 2 (e.g., the envelope surface of the above-mentioned container). Such a gap is illustrated in greater detail in FIGS. 3 and 4 and 6 to 8 (see the element 30 in those figures) and described further in the following.

The press apparatus 100 comprises a pressure medium flow distribution adjuster 9 arranged at the outlet 8 of the pressure medium flow path 6. In FIG. 1, the at least one pressure medium flow generator is located behind the pressure medium flow distribution adjuster 9. The pressure medium flow distribution adjuster 9 is configured to receive the flow of pressure medium exiting the pressure medium flow path 6 via the outlet 8 thereof. The pressure medium flow distributor adjuster 9 is configured to spread the received flow of pressure medium such that the distribution of the flow of pressure medium through the load compartment 2 conforms to a selected distribution of flow of pressure medium through the load compartment 2.

By means of the provisioning of the pressure medium flow distribution adjuster 9, the distribution of the flow of pressure medium through the load compartment 2 during such circulation of pressure medium within the internal space 5 and the load compartment 2 can be tailored or adapted so as to conform to a selected distribution of flow of pressure medium through the load compartment 2. Thus, a selected flow profile of the pressure medium in the load compartment 2 may be achieved by means of the pressure medium flow distribution adjuster 9. The pressure medium flow distribution adjuster 9 may for example comprise a diffuser, which is in accordance with the embodiment of the present invention illustrated in FIG. 1.

The press apparatus 100 may comprise one or more further pressure medium flow distribution adjusters in addition to (or possibly in alternative to) the pressure medium flow distribution adjuster 9, which may be referred to a first pressure medium flow distribution adjuster 9. In accordance with the embodiment of the present invention illustrated in FIG. 1, the press apparatus 100 may comprise an additional, second pressure medium flow distribution adjuster 13. The second pressure medium flow distribution adjuster 13 may be configured to receive the flow pressure medium exiting the load compartment 2 and converge the flow of pressure medium towards the inlet 7 of the pressure medium flow path 6 such that the converged flow of pressure medium enters the pressure medium flow path 6 at the inlet 7 thereof. The second pressure medium flow distribution adjuster 13 may for example comprise a diffuser, which is in accordance with the embodiment of the present invention illustrated in FIG. 1.

The arrows in the internal space 5/load compartment 2 and in the pressure medium flow path 6 in FIG. 1 indicate exemplifying flow paths of pressure medium during use of the press apparatus 100. FIG. 1 may illustrate the press apparatus 100 during a pressing phase of a treatment cycle, wherein the at least one article is subjected to an increased pressure (e.g., at or about a certain pressure in the pressure vessel 1 and possibly at or about at a certain temperature in the pressure vessel 1) in the pressure vessel 1 during a (e.g., selected) period of time. As illustrated in FIG. 1, there is a flow of pressure medium through the load compartment 2 in a direction from the second end 4 to the first end 3. As further illustrated in FIG. 1, the flow of pressure medium in the pressure medium flow path 6 is directed in the opposite direction. As also illustrated in FIG. 1 (and also at least in FIGS. 3 and 4 and 6 to 8), the pressure medium may also flow along the outer envelope surface of the container defining the load compartment 2, in a direction from the second end 4 to the first end 3. In the illustrated embodiment of the present invention, the load compartment 2 does not take up the entirety of the internal space 5, but the internal space 5 includes a gap 30 (cf. FIGS. 3 and 4 and 6 to 8) between the outer envelope surface of the container defining the load compartment 2 and an inner surface of the pressure cylinder 10, through which gap 30 pressure medium may flow.

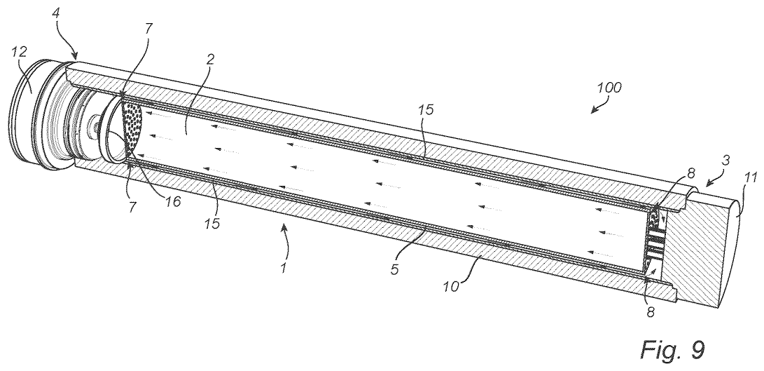

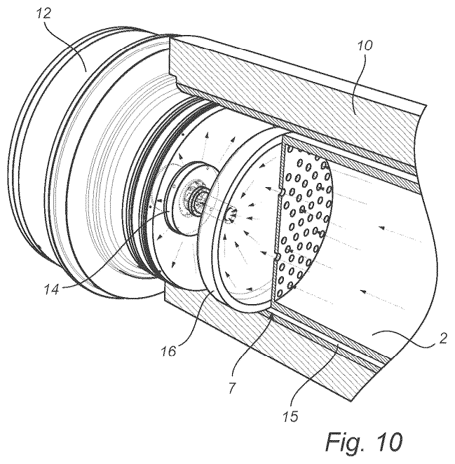

It is to be understood that a configuration of the pressure medium flow path 6 as comprising a tube, pipe or conduit, as illustrated in FIG. 1, is exemplifying and that other configurations are possible, for example a configuration such as described in the following with reference to FIGS. 9 to 12. Also, while embodiments of the present invention may be described herein as comprising one pressure medium flow path, it is to be understood that more than one pressure medium flow path may be provided, which for example may be arranged in parallel with each other. In case there are more than one pressure medium flow path provided, each of the pressure medium flow paths may provide the same functionality of conveying pressure medium therein between the first end 3 of the pressure vessel 1 and the second end 4 of the pressure vessel 1 in order to facilitate creation and/or maintaining of a circulation of pressure medium within the pressure vessel 1, such as in the internal space 5 and the load compartment 2, for example over an extended period of time.

It is to be understood that the press apparatus 100 may include one or more additional components, which are not illustrated in the figures. For example, such one or more additional components could include one or more heaters, which may be arranged within the pressure vessel 1, such as for example, anywhere between the first pressure medium flow distribution adjuster 9 and the second pressure medium flow distribution adjuster 13. Such heater(s) may be configured to (e.g., selectively and/or controllably) heat the pressure medium within the pressure vessel 1, e.g., the pressure medium within the internal space 5 or within the load compartment 2. Such heater(s) may for example comprise one or more heating elements, e.g., electrical heating element(s), and/or one or more heat exchangers.

As has been mentioned previously, on or at the outer surface of the outer walls of the pressure vessel 1 pre-stressing means—for example in the form of wires which may be wound in a plurality of turns so as to form one or more bands and possibly in several layers—may be provided (such prestressing means are not shown in FIG. 1). In case the pressure vessel 1 would be of so-called monoblock type, such prestressing means might not be used. The heater(s) could in alternative or in addition be arranged on the outside of the pressure vessel, for example on an outer side of the surface of any prestressing means as mentioned above, or directly on the outer surface of the outer walls of the pressure vessel 1 in case the pressure vessel 1 is of monoblock type. Any heater(s) on the outside of the pressure vessel 1 may be operated (e.g., controllably operated) to maintain a certain temperature within the pressure vessel 1 and/or in order to provide a certain heating power which may be desired or required during a heating phase. Any heater(s) on the outside of the pressure vessel 1 may for example comprise one or more heating elements (e.g., electrical heating element(s)), and/or a heating medium circuit. The heating medium circuit may for example extend along at least a portion of the outer surface of the pressure vessel 1 and may be configured to circulate a heating medium therein. The heating medium may be at a selected temperature and thereby include a certain amount of thermal energy. During circulation of the heating medium in the heating medium circuit there may be a transfer of thermal energy from the heating medium to the wall of the pressure vessel, such that thermal energy is transferred to the interior of the pressure vessel 1, in particular to the pressure medium within the pressure vessel 1, e.g., the pressure medium within the internal space 5 or within the load compartment 2 (e.g., the pressure medium flowing in the gap 30 illustrated in FIGS. 3 and 4 and 6 to 8). The heating medium used in the heating medium circuit may for example comprise an oil.

FIG. 2 is a schematic view of a portion of the press apparatus 100 illustrated in FIG. 1 at the second end 4 of the pressure vessel 1 of the press apparatus 100. In FIG. 2, the pressure medium flow distribution adjuster 9 is not shown, thereby affording a view of the pressure medium flow generator, which is indicated by reference numeral 14 in FIG. 2. In accordance with the embodiment of the present invention illustrated in FIGS. 1 and 2, the pressure medium flow generator 14 is constituted by a pump. As illustrated in FIG. 2, an inlet of the pump is fluidly coupled to the outlet 8 of the tube, pipe or conduit defining the pressure medium flow path 6 by means an additional tube, pipe or conduit having several bends. The additional tube, pipe or conduit could possibly be considered as a part the pressure medium flow path 6; the outlet 8 would then be at the point of coupling to the inlet of the pump. As illustrated in FIG. 2 by the arrows in and emanating from the pump, the pump may output pressure medium radially. The pressure medium output from the pump can then be received by the pressure medium flow distribution adjuster 9, which subsequently can spread the received flow of pressure medium such that the distribution of the flow of pressure medium through the load compartment 2 conforms to a selected distribution of flow of pressure medium through the load compartment 2.

It is to be understood that the configuration of the pressure medium flow generator 14 as being constituted by a pump, its coupling to the pressure medium flow path 6, and its radially directed output of pressure medium as described in the foregoing are according to examples and other arrangements/configurations are possible. For example, the pressure medium flow generator 14 could in alternative or in addition comprise a fan and/or an ejector, and the pressure medium flow generator could be arranged at another location in the press apparatus 100, for example at another location within the pressure vessel 1.

FIG. 3 is a schematic view of a portion of the press apparatus 100 illustrated in FIG. 1 at the first end 3 of the pressure vessel 1 of the press apparatus 100. FIG. 3 illustrates in greater detail than in FIG. 1 the exemplifying flow of pressure medium in the load compartment 2 at the first end 3 of the pressure vessel 1 and into the second pressure medium flow distribution adjuster 13. The arrows in the depicted portion of the load compartment 2 illustrate flow of pressure medium. According to the illustrated embodiments, the depicted end of the load compartment 2 includes through-holes distributed radially through which the pressure medium in the load compartment 2 exits the load compartment 2 and flows to or towards the second pressure medium flow distribution adjuster 13. The second pressure medium flow distribution adjuster 13 may be configured to receive the flow pressure medium exiting the load compartment 2 and converge the flow of pressure medium towards the inlet 7 of the pressure medium flow path 6—for example according to the exemplifying flow of pressure medium illustrated by the arrows in the second pressure medium flow distribution adjuster 13—such that the converged flow of pressure medium enters the pressure medium flow path 6 at the inlet 7 thereof. As mentioned, the second pressure medium flow distribution adjuster 13 may for example comprise a diffuser, which is in accordance with the embodiment of the present invention illustrated in FIGS. 1 and 3.

FIG. 4 is a schematic view of a portion of the press apparatus 100 illustrated in FIG. 1 at the second end 4 of the pressure vessel 1 of the press apparatus 100. FIG. 4 illustrates in greater detail than in FIG. 1 the exemplifying flow of pressure medium into the load compartment 2 at the second end 4 of the pressure vessel 1 from the first pressure medium flow distribution adjuster 9. As mentioned, the first pressure medium flow distribution adjuster 9 may for example comprise a diffuser, which is in accordance with the embodiment of the present invention illustrated in FIGS. 1, 2 and 4. As illustrated in FIG. 4 as well as in FIGS. 1 and 2, the end of load compartment 2 at the second end 4 of the pressure vessel 1 may comprise a plurality of through-holes permitting passage of pressure medium therethrough. Similarly, also the end of load compartment 2 at the first end 3 of the pressure vessel 1 may comprise a plurality of through-holes permitting passage of pressure medium therethrough, as illustrated in FIG. 1 as well as in FIG. 3.

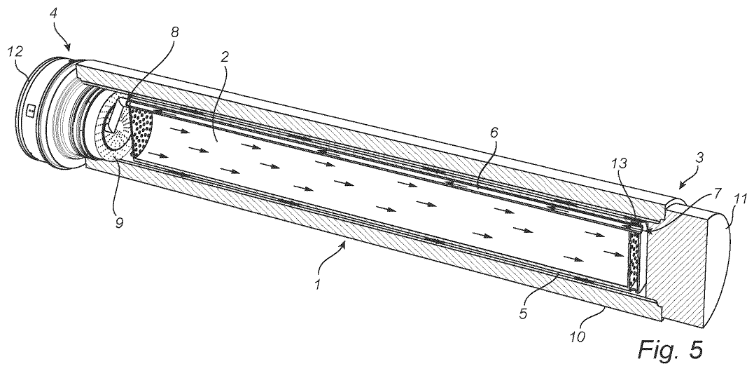

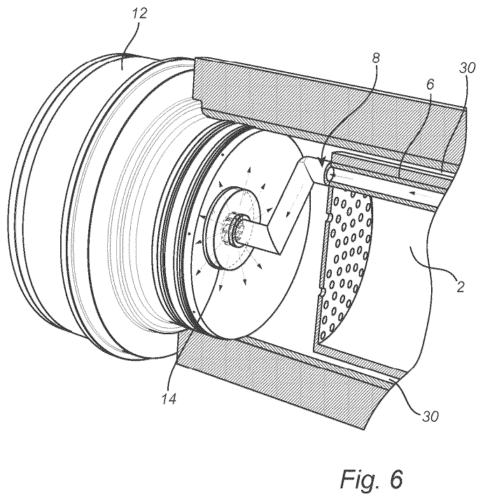

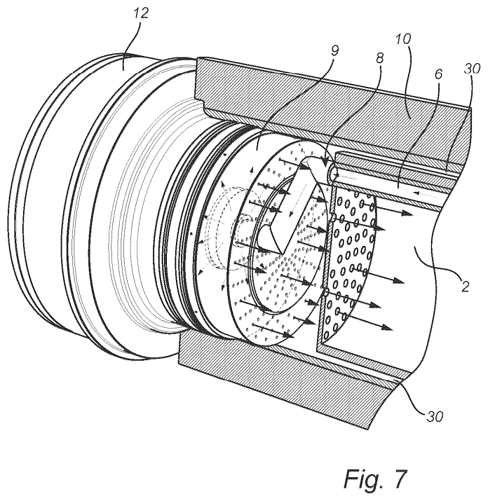

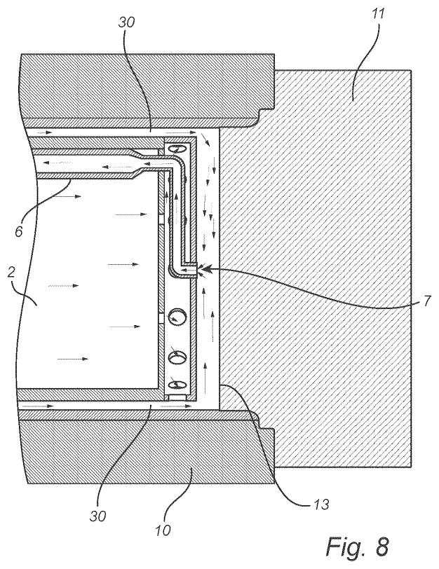

FIG. 5 is a schematic, in part sectional, perspective view of a press apparatus 100 according to an embodiment of the present invention. The press apparatus 100 illustrated in FIG. 5 is similar to the press apparatus 100 illustrated in FIG. 1, and the same reference numerals in FIGS. 1 and 5 denote the same or similar components or elements having the same or similar function. Each of FIGS. 6 and 7 is a schematic view of a portion of the press apparatus 100 illustrated in FIG. 5 at the second end 4 of the pressure vessel 1 of the press apparatus 100. FIG. 8 is a schematic view of a portion of a press apparatus 100 similar to the one illustrated in FIG. 5 at the first end 3 of the pressure vessel 1 of the press apparatus 100. Compared to the press apparatus 100 illustrated in FIG. 1, in the press apparatus 100 illustrated in FIG. 5 the pressure medium flow path 6 is positioned differently in the load compartment 2. As illustrated in FIGS. 5 to 8, the pressure medium flow path 6 is extending parallel to an axial direction of the pressure vessel 1 and of the load compartment 2, but the tube, pipe or conduit defining the pressure medium flow path 6 in the press apparatus 100 illustrated in FIGS. 5 to 8 extends close to or in contact with an inner surface of the load compartment 2, whereas in the press apparatus 100 illustrated in FIGS. 1 to 4, the tube, pipe or conduit defining the pressure medium flow path 6 extends centrally within the load compartment 2. The (portion of the) press apparatus 100 illustrated in FIG. 8 differs slightly from the press apparatus 100 illustrated in FIG. 5 in that in the press apparatus 100 illustrated in FIG. 8, the inlet 7 of the pressure medium flow path 6 is arranged at or close to a longitudinal axis of the load compartment 2, whereas in the press apparatus 100 illustrated in FIG. 5, the inlet 7 of the pressure medium flow path 6 is arranged at a distance from the longitudinal axis of the load compartment 2, at the periphery of the load compartment 2. It is to be understood that other locations of the inlet 7 of the pressure medium flow path 6, e.g., in relation to the load compartment 2, are possible.

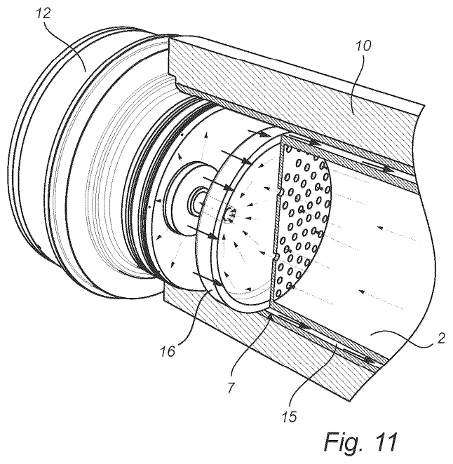

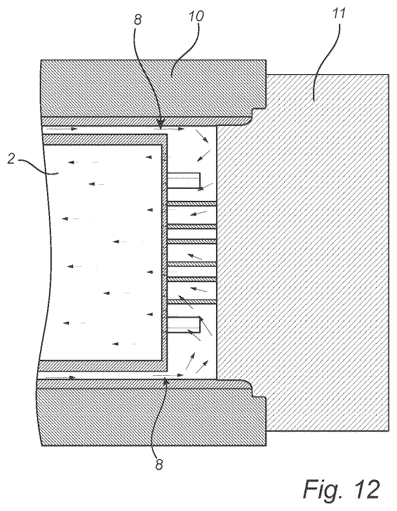

FIG. 9 is a schematic, in part sectional, perspective view of a press apparatus 100 according to an embodiment of the present invention. The press apparatus 100 illustrated in FIG. 9 is similar to the press apparatus 100 illustrated in FIG. 1 or 5, and the same reference numerals in FIG. 9 and in FIG. 1 or 5 denote the same or similar components or elements having the same or similar function. Each of FIGS. 10 and 11 is a schematic view of a portion of the press apparatus 100 illustrated in FIG. 9 at the second end 4 of the pressure vessel 1 of the press apparatus 100. FIG. 12 is a schematic view of a portion of the press apparatus 100 illustrated in FIG. 9 at the first end 3 of the pressure vessel 1 of the press apparatus 100.

The press apparatus 100 illustrated in FIG. 9 differs from the press apparatus 100 illustrated in FIG. 1 or 5 for example in that the (at least one) pressure medium flow path is not implemented as tube, pipe or conduit defining the pressure medium flow path, but is realized in a different way, as will be described further in the following.

The press apparatus 100 illustrated in FIG. 9 further differs from the press apparatus 100 illustrated in FIG. 1 or 5 in that as illustrated in FIG. 9, there is a flow of pressure medium through the load compartment 2 in a direction from the first end 3 to the second end 4. As also illustrated in FIG. 9 (and also at least in FIGS. 11 and 12), the pressure medium may flow along the outer envelope surface of the container defining the load compartment 2, in a direction from the second end 4 to the first end 3.

According to the embodiment of the present invention illustrated in FIGS. 9 to 12 there is a gap 15 between the outer envelope surface of the container defining the load compartment 2 and an inner surface of the pressure cylinder 10, through which gap pressure medium may flow. According to the embodiment of the present invention illustrated in FIGS. 9 to 12, the gap 15 defines the said pressure medium flow path, which gap hence may be referred to as the pressure medium flow path 15. The pressure medium flow path 15 extends between the inlet 7 located at the second end 4 and the outlet 8 located at the first end 3.

According to the embodiment of the present invention illustrated in FIGS. 9 to 12, the internal space 5 is defined by the load compartment 2. In other words, according to the embodiment of the present invention illustrated in FIGS. 9 to 12, the load compartment 2 and the internal space 5 coincide. Thus, the inlet 7 and outlet 8 are in fluid communication with the internal space 5, and the pressure medium flow path 15 is configured to guide pressure medium from the inlet 7 to the outlet 8.

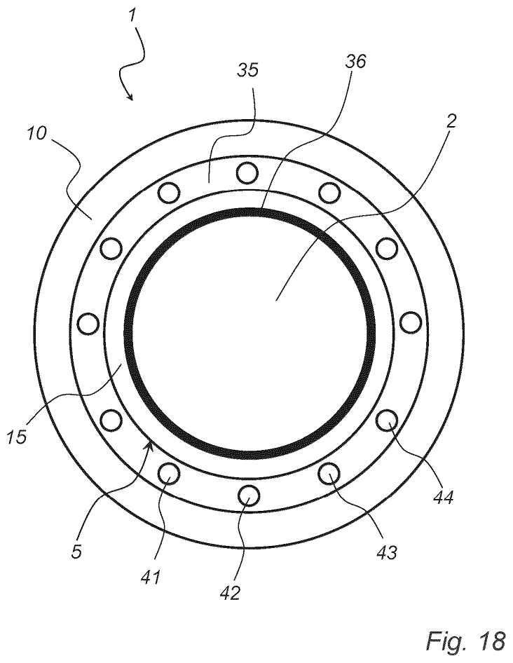

It is to be noted that the way in which the (at least one) pressure medium flow path is realized or implemented is not limited that the ways illustrated in, e.g., FIG. 1, 5 or 9, and that yet other ways of realizing or implementing the (at least one) pressure medium flow path are possible. For example, the gap defining the pressure medium flow path 15 in FIG. 9 could be replaced by a semi-solid liner or jacket, which may include one or more conduits, pipes, passageways or the like extending within the liner or jacket along the length of the container defining the load compartment 2. In alternative, a part of the gap defining the pressure medium flow path 15 in FIG. 9 could accommodate such a liner or jacket. An example of such a solution will be described in the following with reference to FIG. 18. In alternative or in addition, the pressure medium flow path could be realized by means of one or more conduits, channels, pipes, passageways or the like arranged within the walls of the container defining the load compartment 2 and/or within the load compartment 2 and which may be extending along a length of the container defining the load compartment 2. For example, the container defining the load compartment 2 could be configured as a cylinder, with such one or more conduits, channels, pipes, passageways or the like being arranged within the cylindrical walls of the container and/or within the container and which may run along at least a part of the length thereof. According to another example, the flow of pressure medium through the load compartment 2 may be in an opposite direction to what is illustrated in FIG. 9, and accordingly the flow of pressure medium through the gap defining the pressure medium flow path 15 may also be in an opposite direction to what is illustrated in FIG. 9. In such a case, there could be provided a pressure medium flow distribution adjuster as described herein, e.g., comprising a diffusor, upstream the load compartment 2, which pressure medium flow distribution adjuster may be configured to spread the flow of pressure medium such that the distribution of the flow of pressure medium through the load compartment 2 conforms to a selected distribution of flow of pressure medium through the load compartment 2.

As perhaps best illustrated in FIGS. 10 and 11, the press apparatus 100 may comprise a pressure medium flow guiding element 16, which may be configured to collect and/or converge the flow of pressure medium exiting the load compartment 2 in order to facilitate for the pressure medium flow generator 14 to receive the flow of pressure medium. The pressure medium flow guiding element 16 may also help in ensuring that the entirety, or substantially the entirety, of the flow of pressure medium that is exiting the load compartment 2 is subsequently guided (e.g., forced) into the gap 15 via the pressure medium flow generator 14. In accordance with the embodiment of the present invention illustrated in FIGS. 9 to 12, the gap 15 defines the said pressure medium flow path.

While not illustrated in FIG. 9 or 12, the press apparatus 100 illustrated in FIGS. 9 to 12 may comprise a pressure medium flow distribution adjuster, e.g., comprising a diffuser, arranged at the outlet 8 of the pressure medium flow path 15. The pressure medium flow distribution adjuster may be configured to receive the flow of pressure medium exiting the pressure medium flow path 15 via the outlet 8 thereof, and to spread the received flow of pressure medium such that the distribution of the flow of pressure medium through the load compartment 2 conforms to a selected distribution of flow of pressure medium through the load compartment 2.

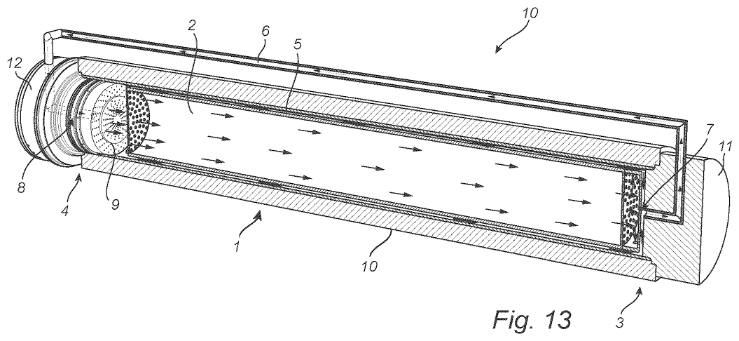

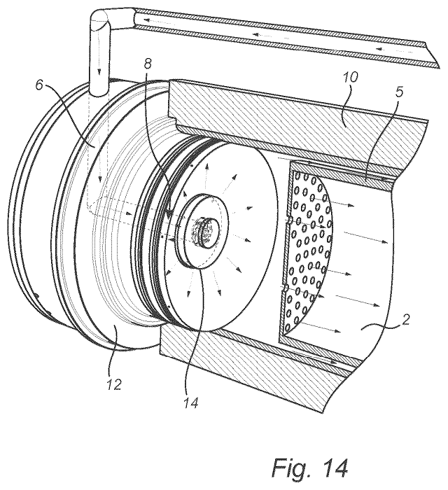

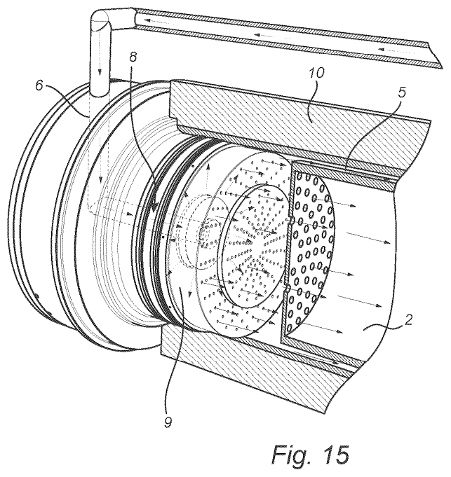

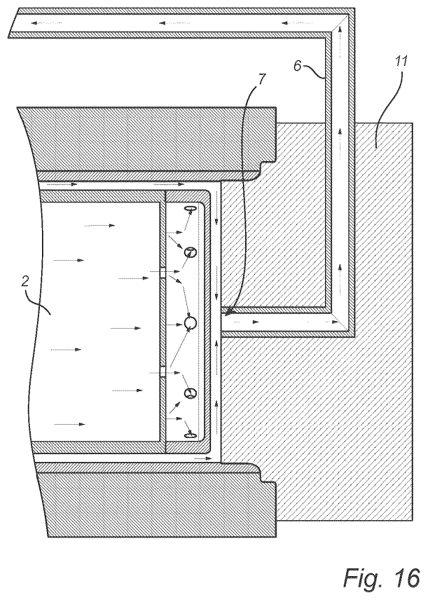

FIG. 13 is a schematic, in part sectional, perspective view of a press apparatus 100 according to an embodiment of the present invention. The press apparatus 100 illustrated in FIG. 13 is similar to the press apparatus 100 illustrated in FIG. 1 or 5, and the same reference numerals in FIG. 13 and in FIG. 1 or 5 denote the same or similar components or elements having the same or similar function. Each of FIGS. 14 and 15 is a schematic view of a portion of the press apparatus 100 illustrated in FIG. 13 at the second end 4 of the pressure vessel 1 of the press apparatus 100. FIG. 16 is a schematic view of a portion of the press apparatus 100 illustrated in FIG. 13 at the first end 3 of the pressure vessel 1 of the press apparatus 100. Compared to the press apparatus 100 illustrated in FIG. 1 or 5, in the press apparatus 100 illustrated in FIG. 13, the tube, pipe or conduit defining the pressure medium flow path 6 does not extend within the load compartment 2 but extends at least in part outside the pressure vessel 1. Generally, the (at least one) pressure medium flow path 6 may exit the pressure vessel at one of the first end 3 and the second end 4 and enter the pressure vessel at the other one of the first end 3 and the second end 4. In accordance with the embodiment of the present invention illustrated in FIGS. 13 to 16, the pressure medium flow path 6 exits the pressure vessel 1 at the first end 3 and enters the pressure vessel 1 at the second end 4. Except for that the pressure medium flow path 6 does not extend within the load compartment 2 and instead extends at least in part outside the pressure vessel 1, the function of the components or elements having the same reference numerals in FIGS. 13 to 16 and in FIG. 1 to 4 or 5 to 8 are the same or similar.

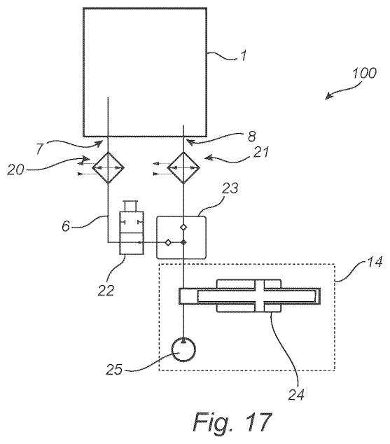

FIG. 17 is a schematic view of a press apparatus 100 according to an embodiment of the present invention. The press apparatus 100 comprises a pressure vessel 1. While the pressure vessel 1 is only very schematically shown in FIG. 17, the pressure vessel 1 may be generally configured in the same way or similar to the pressure vessel 1 of the press apparatus 100 illustrated in FIG. 13. Just as in the press apparatus 100 illustrated in FIG. 13, in the press apparatus 100 illustrated in FIG. 17 the (at least one) pressure medium flow path 6 is arranged at least in part outside the pressure vessel 1. While FIG. 17 schematically illustrates the pressure medium flow path 6 exiting the pressure vessel 1 at one location and entering the pressure vessel 1 at another location, the pressure medium flow path may exit the pressure vessel 1 at one of the first end and the second end and enter the pressure vessel 1 at the other one of the first end and the second end (the first end and the second end of the pressure vessel 1 are not indicated in FIG. 17; cf, e.g., FIG. 13). As in FIG. 13, the pressure medium flow path 6 in FIG. 17 is defined by a tube, pipe or conduit.

The press apparatus 100 illustrated in FIG. 17 comprises a cooling unit 20, which is arranged downstream the inlet 7 of the pressure medium flow path 6 and configured to cool the pressure medium being guided in the pressure medium flow path 6.

The press apparatus 100 comprises a pressure medium flow generator 14 which is arranged downstream the cooling unit 20. The pressure medium flow generator 14 is configured to receive the flow of the pressure medium having been cooled by the cooling unit 20 and generate a flow of the pressure medium in the pressure medium flow path 6 towards the outlet 8 of the pressure medium flow path 6.

The cooling unit 20 is configured to cool the pressure medium guided in the pressure medium flow path 6 such that the temperature of the pressure medium received the pressure medium flow generator 14 does not exceed a selected temperature.

The press apparatus 100 comprises a heating unit 21 which is arranged downstream the pressure medium flow generator 14 and upstream the outlet of the pressure medium flow path 6. The heating unit 21 is configured to heat the pressure medium guided in the pressure medium flow path 6 such that the temperature of the pressure medium in the pressure medium flow out of the outlet 8 of the pressure medium flow path 6 exceeds or conforms to a selected temperature.

A configuration of the press apparatus 100—and particularly a configuration of the pressure medium flow path 6—such as illustrated in FIG. 17 may be particularly advantageous in case the pressure medium flow generator 14 is of a type or configuration that may not function or operate properly or even malfunction in case the temperature of the pressure medium received by the pressure medium flow generator 14 would be relatively high. For example, the press apparatus 100 may be configured to treat at least one article by means of isostatic pressing, in which case the temperature of the pressure medium may become relatively high during use of the press apparatus 100. In case the temperature of the pressure medium guided into the pressure medium flow path 6 becomes too high for the pressure medium flow generator 14 to function properly, the cooling unit 20 may cool the pressure medium being guided in the pressure medium flow path 6 such that the temperature of the pressure medium received by the pressure medium flow generator 14 does not exceed a temperature above which the pressure medium flow generator 14 may not function or operate properly or possibly even malfunction. Then, the heating unit 21 may heat the pressure medium being guided in the pressure medium flow path 6 such that the temperature of the pressure medium in the pressure medium flow out of the outlet 8 exceeds or conforms to a selected temperature, which may be a temperature equal to or about the temperature of the pressure medium when guided into pressure medium flow path 6 via the inlet 7.

For example, and in accordance with the embodiment of the present invention illustrated in FIG. 17, the pressure medium flow generator 14 may comprise a pressure intensifier 24 and a pump 25, which pump 25 may be referred to as a feeding pump. The pressure intensifier 24 may not function or operate properly or even malfunction in case the temperature of the pressure medium received by the pressure medium flow generator 14 (e.g., the pressure intensifier 24) would be relatively high. The cooling unit 20 may cool the pressure medium in the pressure medium flow path 6 to ensure that the temperature of the pressure medium received by the pressure medium flow generator 14 (e.g., the pressure intensifier 24) does not exceed a temperature for which the pressure medium flow generator 14, such as the pressure intensifier 24, is not rated.

Each or any of the cooling unit 20 and the heating unit 21 may for example comprise one or more heat exchanger units, although another or other types of heating/cooling units are possible.

In accordance with the embodiment of the present invention illustrated in FIG. 17, the press apparatus 100 comprises a control valve 22 arranged downstream the cooling unit 20 and a check valve assembly 23 arranged downstream the control valve 22. As illustrated in FIG. 17, the check valve assembly 23 takes as input the pressure medium output from the cooling unit 20 and outputs pressure medium that is fed or conveyed to the heating unit 21. As also illustrated in FIG. 17, the check valve assembly 23 is further fluidly coupled with the pump 25. The control valve 22 and the check valve assembly 23 can be used to control the flow of pressure medium output from the pressure intensifier 24. The pump 25, which may be operating at relatively low pressure, can be used to feed the pressure intensifier 24 with pressure medium, e.g., comprising oil and/or any other fluid such as water.

A pressurization phase of a treatment cycle, i.e., when the pressure in the pressure vessel 1 is increased to a certain pressure level, may involve the following operations. The pump 25 feeds the pressure intensifier 24 with pressure medium. As the pressure intensifier 24 carries out strokes, pressure is increased in the pressure medium input to the pressure intensifier 24 and the pressurized pressure medium is conveyed (e.g., pumped) to the check valve assembly 23. During this operation, the control valve 22 is closed (i.e., to permit no or only an insignificant amount of flow of pressure medium therethrough) and all pressure medium is conveyed (e.g., pumped) to the heating unit 21. The heat exchanger 21 may heat the pressure medium to a certain temperature or such that the temperature of the pressure medium exceeds certain temperature before the pressure medium enters the pressure vessel 1 via the outlet 8. The pressure intensifier 24 is operated until a selected pressure level has been reached in the pressure vessel 1. Operation of the pump 25 and the pressure intensifier 24 may then be stopped.

A pressing phase of the treatment cycle, wherein the at least one article is subjected to an increased pressure (e.g., at or about a certain pressure in the pressure vessel 1 and possibly at or about at a certain temperature in the pressure vessel 1) in the pressure vessel 1 during a (e.g., selected) period of time may involve the following. During the pressing phase, the control valve 22 is open (e.g., so as to permit flow of pressure medium therethrough). Instead of pressure medium being fed to the pressure intensifier 24 by the pump 25, pressure medium from the cooling unit 20 is conveyed through control valve 22 and fed to the pressure intensifier 24 via the check valve assembly 23. For example by making the pressure intensifier shifting stroke direction and making pumping strokes, the pressure medium may be directed to the heating unit 21 via the check valve assembly 23.

FIG. 18 is a schematic, cross-sectional view of a pressure vessel 1 of a press apparatus according to an embodiment of the present invention. The same reference numerals in FIG. 18 and in the previously referenced figures denote the same or similar components or elements, having the same or similar function. FIG. 18 illustrates a way of realizing or implementing the said (at least one) pressure medium flow path. According to the embodiment of the present invention illustrated in FIG. 18, the pressure vessel 1 has a cylindrical shape, and FIG. 18 illustrates a cross-section of the pressure vessel 1 in a plane perpendicular to a longitudinal axis of the pressure vessel 1.

According to the embodiment of the present invention illustrated in FIG. 18, there is a (e.g., cylindrical) liner (or jacket) 35 within the pressure vessel 1 arranged in proximity to and possibly coupled to an inner surface of the pressure cylinder 10, such as indicated in FIG. 18. The interior of the liner 35 defines the internal space 5, in which a (e.g., cylindrical) container 36, which may define the load compartment 2, is arranged. As illustrated in FIG. 18, there may be a gap 15 between an outer envelope surface of the container 36 and the liner 35 through which pressure medium may flow, similar to the gap 15 illustrated in FIG. 9.

According to the embodiment of the present invention illustrated in FIG. 18, there is provided a plurality of pressure medium flow paths (e.g., comprising conduits, pipes or the like), some of which are indicated by reference numerals 41, 42, 43 and 44 in FIG. 18, within the liner 35. Each of the pressure medium flow paths 41, 42, 43 and 44 may extend along at least a part of the length of the liner 35, e.g., in a direction parallel or substantially parallel to a longitudinal axis of the liner 35.

Each of the pressure medium flow paths 41, 42, 43, 44 may have an inlet (not shown in FIG. 18) at the first end (not shown in FIG. 18) of the pressure vessel 1 and an outlet (not shown in FIG. 18) at the second end (not shown in FIG. 18) of the pressure vessel 1, with the inlet and outlet being in fluid communication with the internal space 5. Each of the pressure medium flow paths 41, 42, 43, 44 may be configured to guide pressure medium from the inlet to the outlet.

According to the embodiment of the present invention illustrated in FIG. 18, there may be flow of pressure medium through the load compartment 2 in a direction from the first end to the second end (or vice versa), and further a flow of pressure medium through the pressure medium flow paths 41, 42, 43, 44 in a direction from the second end to the first end (or vice versa). Thus, pressure medium which enters the load compartment 2 at, e.g., the first end of the pressure vessel 1 and flows through the load compartment 2 to or towards the second end of the pressure vessel 1 may be brought back to or towards the first end of the pressure vessel 1 by means of the pressure medium flow paths 41, 42, 43, 44.

The pressure medium flow paths 41, 42, 43, 44 may be joined so as to share the same outlet. However, this is not required. Rather, each or any pressure medium flow path might have its own outlet, or some pressure medium flow paths could be joined to share one outlet and other pressure medium flow paths could be joined to share another outlet. Further, the pressure medium flow paths 41, 42, 43, 44 could be joined so as to share the same inlet, or some pressure medium flow paths could be joined to share one inlet and other pressure medium flow paths could be joined to share another inlet. Thus, it is not necessarily required that each pressure medium flow path 41, 42, 43, 44 has its own inlet. Also, it is to be understood that the number of pressure medium flow paths illustrated in FIG. 18 is according to an example, and that there could be fewer or more pressure medium flow paths than illustrated in FIG. 18.

FIG. 19 is a schematic, in part sectional, perspective view of a press apparatus 100 according to an embodiment of the present invention. The press apparatus 100 illustrated in FIG. 19 is similar to the press apparatus 100 illustrated in FIG. 1, and the same reference numerals in FIGS. 1 and 19 denote the same or similar components or elements having the same or similar function. Each of FIGS. 20 and 21 is a schematic view of a portion of the press apparatus 100 illustrated in FIG. 19 at the second end 4 of the pressure vessel 1 of the press apparatus 100. Compared to the press apparatus 100 illustrated in FIG. 1, the press apparatus 100 illustrated in FIGS. 19 to 21 comprises a first pressure medium flow distribution adjuster 9 which is of a different type than illustrated in FIG. 1 and in FIGS. 4, 5, 7, 13, 15. The first pressure medium flow distribution adjuster 9 illustrated in FIGS. 1, 4, 5, 7, 13, 15, and 19-21 comprises a diffuser, which is arranged at the outlet 8 of the pressure medium flow path 6. The pressure medium flow distribution adjuster 9 is configured to receive the flow of pressure medium exiting the pressure medium flow path 6 via the outlet 8 thereof. The pressure medium flow distributor adjuster 9 is configured to spread the received flow of pressure medium such that the distribution of the flow of pressure medium through the load compartment 2 conforms to a selected distribution of flow of pressure medium through the load compartment 2.

The first pressure medium flow distribution adjuster 9 illustrated in FIGS. 1, 4, 5, 7, 13 and 15 comprises a diffuser of a type including a bowl-like element having a plurality of through-holes permitting pressure medium to flow therethrough. The first pressure medium flow distribution adjuster 9 illustrated in FIGS. 19 to 21 comprises a diffuser of a different type which may be referred to as a volute pump diffuser. The volute pump diffuser type of diffuser illustrated in FIGS. 19 to 21 is configured to receive the flow of pressure medium exiting the pressure medium flow path 6 via the outlet 8 thereof in a volute inside which pressure medium may flow. As perhaps best illustrated in FIGS. 20 and 21, the diffuser comprises a ring-shaped structure inside which pressure medium may flow, which ring-shaped structure is in fluid communication with the volute comprises holes by means of which the pressure medium is output from the diffuser and spread such that the distribution of the flow of pressure medium through the load compartment 2 conforms to a selected distribution of flow of pressure medium through the load compartment 2.

It is to be understood that a first pressure medium flow distribution adjuster 9 in the form of a volute pump diffuser may be employed in any embodiment of the present invention as described herein, such as in alternative to or in combination with the diffuser illustrated in FIGS. 1, 4, 5, 7, 13 and 15. A combination of a type of diffuser illustrated in FIGS. 1, 4, 5, 7, 13 and 15 and a volute pump diffuser type diffuser is illustrated in FIG. 19, where a diffuser of the type illustrated in FIGS. 1, 4, 5, 7, 13 and 15 is arranged downstream the volute pump diffuser type diffuser. However, the diffuser of the type illustrated in FIGS. 1, 4, 5, 7, 13 and 15 could be omitted. In FIGS. 20 and 21, that diffuser is not shown in order to better illustrate the volute pump diffuser type diffuser. Moreover, any of the first pressure medium flow distribution adjuster and the second pressure medium flow distribution adjuster described herein may comprise a diffuser of the type illustrated in FIGS. 1, 4, 5, 7, 13 and 15, a diffuser of the type illustrated in FIGS. 19 to 21, and/or another type of diffuser.

In conclusion, a press apparatus is disclosed, comprising a pressure vessel having an internal space and a first end and a second end. A load compartment is arranged within the internal space at least in part between the first end and the second end and arranged so that a flow of pressure medium through the load compartment is permitted. At least one pressure medium flow path has and extends between an inlet and an outlet in fluid communication with the internal space, and is configured to guide pressure medium from the inlet to the outlet. At least one pressure medium flow generator is configured to generate a flow of pressure medium within the internal space going through the load compartment between the second end and the first end, and further to generate a flow of the pressure medium into the inlet, through the at least one pressure medium flow path, and out of the outlet.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A press apparatus configured to treat at least one article, the press apparatus comprising:
a pressure vessel having an internal space and a first end and a second end, the pressure vessel being arranged to hold pressure medium within the internal space during use of the press apparatus;
a load compartment arranged within the internal space at least in part between the first end and the second end and arranged so that a flow of pressure medium through the load compartment is permitted, the load compartment being arranged to hold at least one article therein during use of the press apparatus;
at least one pressure medium flow path having and extending between an inlet located at one of the first end and the second end and an outlet located at the other one of the first end and the second end, the inlet and outlet being in fluid communication with the internal space, the at least one pressure medium flow path being configured to guide pressure medium from the inlet to the outlet;
at least one pressure medium flow generator configured to generate a flow of pressure medium within the internal space going through the load compartment between the second end and the first end, wherein the at least one pressure medium flow generator is further configured to generate a flow of the pressure medium into the inlet, through the at least one pressure medium flow path, and out of the outlet; and
a pressure medium flow distribution adjuster arranged at the outlet and configured to receive the flow of pressure medium exiting the at least one pressure medium flow path via the outlet thereof, the pressure medium flow distributor adjuster being configured to spread the received flow of pressure medium such that the distribution of the flow of pressure medium through the load compartment conforms to a selected distribution of flow of pressure medium through the load compartment.

2. A press apparatus according to claim 1, wherein the at least one pressure medium flow path is arranged at least in part within the internal space.

3. A press apparatus according to claim 1, wherein the at least one pressure medium flow path is arranged at least in part within the pressure vessel in one or more parts thereof different from the internal space.

4. A press apparatus according to claim 1, wherein the at least one pressure medium flow path is arranged at least in part outside the pressure vessel, wherein the at least one pressure medium flow path exits the pressure vessel at one of the first end and the second end and enters the pressure vessel at the other one of the first end and the second end.

5. A press apparatus according to claim 1, wherein the pressure vessel comprises an enclosing structure configured to sealingly enclose at least the internal space, wherein:
at least one of the at least one pressure medium flow generator or the pressure medium flow distribution adjuster is built-in in the enclosing structure;
the enclosing structure comprises at least one cavity in fluid communication with the internal space, wherein at least one of the at least one pressure medium flow generator or the pressure medium flow distribution adjuster is disposed in the at least one cavity; and/or
at least one of the at least one pressure medium flow generator or the pressure medium flow distribution adjuster is recessed in an inner surface of the enclosing structure, the inner surface facing the internal space.

6. A press apparatus according to claim 1, wherein the pressure vessel comprises an enclosing structure configured to sealingly enclose at least the internal space, wherein the enclosing structure comprises a first end closure arranged at one of the first end of the pressure vessel and the second end of the pressure vessel and a second end closure arranged at the other one of the first end of the pressure vessel and the second end of the pressure vessel, wherein:
the at least one pressure medium flow generator is built-in in the first end closure and/or the second end closure;
the pressure medium flow distribution adjuster is built-in in the first end closure and/or the second end closure;
the first end closure and/or the second end closure comprises at least one cavity in fluid communication with the internal space, wherein the at least one pressure medium flow generator is disposed in the at least one cavity;
the first end closure and/or the second end closure comprises at least one cavity in fluid communication with the internal space, wherein the pressure medium flow distribution adjuster is disposed in the at least one cavity;
the at least one pressure medium flow generator is recessed in an inner surface of the first end closure and/or the second end closure, the inner surface facing the internal space; and/or
the pressure medium flow distribution adjuster is recessed in an inner surface of the first end closure and/or the second end closure, the inner surface facing the internal space.

7. A press apparatus according to claim 1, wherein the pressure medium flow distribution adjuster comprises a diffuser.

8. A press apparatus according to claim 1, wherein said pressure medium flow distribution adjuster is a first pressure medium flow distribution adjuster, and with the press apparatus further comprising:
an additional, second pressure medium flow distribution adjuster configured to receive the flow pressure medium exiting the load compartment and converge the flow of pressure medium towards the inlet such that the converged flow of pressure medium enters the at least one pressure medium flow path at the inlet thereof.

9. A press apparatus according to claim 8, wherein the pressure vessel comprises an enclosing structure configured to sealingly enclose at least the internal space, wherein:
at least one of the at least one pressure medium flow generator, the second pressure medium flow distribution adjuster or the first pressure medium flow distribution adjuster is built-in in the enclosing structure;
the enclosing structure comprises at least one cavity in fluid communication with the internal space, wherein at least one of the at least one pressure medium flow generator, the second pressure medium flow distribution adjuster or the first pressure medium flow distribution adjuster is disposed in the at least one cavity; and/or
at least one of the at least one pressure medium flow generator, the second pressure medium flow distribution adjuster, or the first pressure medium flow distribution adjuster is recessed in an inner surface of the enclosing structure, the inner surface facing the internal space.

10. A press apparatus according to claim 8, wherein the pressure vessel comprises an enclosing structure configured to sealingly enclose at least the internal space, wherein the enclosing structure comprises a first end closure arranged at one of the first end of the pressure vessel and the second end of the pressure vessel and a second end closure arranged at the other one of the first end of the pressure vessel and the second end of the pressure vessel, wherein:
the at least one pressure medium flow generator is built-in in the first end closure and/or the second end closure;
the first pressure medium flow distribution adjuster is built-in in the one of the first end closure and the second end closure, and the second pressure medium flow distribution adjuster is built-in in the other one of the first end closure and the second end closure;
the first end closure and/or the second end closure comprises at least one cavity in fluid communication with the internal space, wherein the at least one pressure medium flow generator is disposed in the at least one cavity;
one of the first end closure and the second end closure comprises at least one cavity in fluid communication with the internal space, wherein the second pressure medium flow distribution adjuster is disposed in said at least one cavity, and the other one of the first end closure and the second end closure comprises at least one cavity in fluid communication with the internal space, wherein the first pressure medium flow distribution adjuster is disposed in said at least one cavity;
the at least one pressure medium flow generator pressure medium is recessed in an inner surface of the first end closure and/or the second end closure, the inner surface facing the internal space;
the first pressure medium flow distribution adjuster is recessed in an inner surface of one of the first end closure and the second end closure, said inner surface facing the internal space, and the second pressure medium flow distribution adjuster is recessed in an inner surface of the other one of the first end closure and the second end closure, said inner surface facing the internal space.

11. A press apparatus according to claim 8, wherein the second pressure medium flow distribution adjuster comprises a diffuser.

12. A press apparatus according to claim 1, wherein the at least one pressure medium flow generator comprises at least one of: at least one fan, at least one ejector, at least one pump, or at least one pressure intensifier.

13. A press apparatus according to claim 1, wherein the at least one pressure medium flow path is arranged at least in part outside the pressure vessel, wherein the press apparatus further comprises at least one of:
a heating unit configured to heat the pressure medium being guided in the at least one pressure medium flow path from the inlet to the outlet; or
a cooling unit configured to cool the pressure medium being guided in the at least one pressure medium flow path from the inlet to the outlet.

14. A press apparatus according to claim 1, wherein the at least one pressure medium flow path is arranged at least in part outside the pressure vessel, wherein the press apparatus further comprises:
a cooling unit arranged downstream the inlet of the at least one pressure medium flow path and configured to cool the pressure medium being guided in the at least one pressure medium flow path;
wherein at least one of the at least one pressure medium flow generator is arranged downstream the cooling unit and configured to receive the flow of the pressure medium having been cooled by the cooling unit and generate a flow of the pressure medium in the at least one pressure medium flow path towards the outlet;
wherein the cooling unit is configured to cool the pressure medium being guided in the at least one pressure medium flow path such that the temperature of the pressure medium received by said at least one of the at least one pressure medium flow generator does not exceed a selected temperature;
wherein the press apparatus further comprises:
a heating unit arranged downstream said at least one of the at least one pressure medium flow generator and upstream the outlet and configured to heat the pressure medium being guided in the at least one pressure medium flow path such that the temperature of the pressure medium in the pressure medium flow out of the outlet exceeds or conforms to a selected temperature.

15. A press apparatus according to claim 14, wherein said at least one of the at least one pressure medium flow generator comprises at least one pressure intensifier.

16. A press apparatus according to claim 13, wherein the heating unit and/or the cooling unit comprises at least one heat exchanger unit.

17. A press apparatus according to claim 1, wherein the pressure vessel comprises a pressure cylinder, a first end closure and a second end closure, the second end closure being opposite to the first end closure, wherein the first end closure is at one of the first end of the pressure vessel and the second end of the pressure vessel and the second end closure is at the other one of the first end of the pressure vessel and the second end of the pressure vessel.
